(19) United States
(12) Patent Application Publication
(10) Pub. No.: US 2011/0001022 A1
(43) Pub. Date: Jan. 6, 2011

(54) Universal holding device

(76) Inventor: Alfred R. Edinger, Toms River, NJ (US)

Correspondence Address: ALFRED EDINGER, 14 SUMNER AVENUE, TOMS RIVER, NJ, 08755, US

(21) Appl. No.: 12/806,924

(22) Filed: Aug. 24, 2010

Related U.S. Application Data
(63) Continuation-in-part of application No. 12/381,450, filed on Mar. 12, 2009, now abandoned.

(51) Int. Cl. A47D 15/00; F16B 2/02

(52) U.S. Cl. 248/103; 248/316.1

(57) ABSTRACT

Universal Holding Device has two embodiments, second one possess most of basic parts. One has an inverted “U” Shape and other has “L” shape designs.

“U” shape design has three Holding Device Bodies, all have: Support Bracket, on right side of lower limb, moving left, than up is Clamping Device, move to upper limb, turn right is Clamping Device, move right than up is lower half of Hinge, On top is upper half of Hinge with a permanent securing device: i.e. Bolt, Nut, and temporary securing pin: i.e. Quick Release Pin, moving right is Ratchet-tooth, that rotates Adjustable Arm, 240°, moving right and resting on Adjustable Arm is Junction Bracket,: i.e. two short tubes, one on top of the other forming a plus sign, each tube has its own Thumb Screws/Pull-Pins, turn right and inserted into other tube of Junction Bracket is Adjustable Rod, moving down to end is Attachment Bracket, with its Quick Release Pin. All Serviceable Devices are permanently attached at factory to Quick Attachment Rod. Said devices are inserted into Attachment Bracket, and secured with Quick Release Pin.

“L” shape design is same up to and including Hinge, and from here all remaining parts are configure to meet customers requirements, e.g. more than one Ratchet-tooth, may be used and configured differently, Junction Bracket, is deleted, and Adjustable Arm, are connecting devices between Ratchet-tooth, and are configured differently and made in different lengths, but at end is Attachment Bracket, for attaching Serviceable Devices.

### CROSS-REFERENCE TO RELATED APPLICATIONS

This is a Continuation in Part of application Ser. No. 12/381,450, Filed on Mar. 12, 2009, with enhanced design.

### FEDERALLY SPONSORED RESEARCH

Not Applicable

### SEQUENCE LISTING OR PROGRAM

Not Applicable

### BACKGROUND OF THE INVENTION

1. Field

This application relates to Universal Holding Device for domestic and industrial use for holding light, medium, and heavy, weight items.

2. Prior Art-Advantages

There are no Universal Holding Devices, only specialized holding devices for holding specific items. There's no versatile Baby Bottle Holders presently in the market place, which are designed to meet customers' requirements. Baby Bottle Holders listed below appear to be designed for very limited/specific use.

Several types of holding devices are listed below—for example, Baby Bottle Holders, U.S. Pat. No. 6,598,838 B2, (2003); U.S. Pat. No. D462,775 S (2002); Book Holder; U.S. Pat. No. 7,152,840,B2, (2006); Food & Drink Holder, U.S. Pat. No. 7,360,747; U.S. Pat. No. D557,495 S, Ornamental Portable Holding Device, (2007); and U.S. Pat. No. D560,088, Ornamental Equipment Holding Device (2008).

This device will fill the void for Universal Holding Devices and Baby Bottle Holders, listed here-in and more. Prior Art doesn't possess components and material that this invention proposes. With today's modern technology this multi-purpose device can be easily adapted to perform a variety task and be marketed for a reasonable priced.

### SUMMARY OF INVENTION

Universal Holding Device with it's two embodiments is a multi-purpose device that will provide countless hours of assistance for domestic and industrial use. It is easy to install competently, and operate safely. It has ability to hold a variety of light, medium and heavy weight Serviceable Devices. It can be manufactured with a variety of materials (e.g. plastics, carbon fiber, aluminum & steel). It can be attached temporally or permanently using several different devices to a variety of different secure items/material. First embodiment has an inverted U-Shape design consisting of: Three different styles of Holding Device Bodies for quick and easy attachment to a stable fixture; Four different styles of Hinges with temporary locking position(s) for inserting Quick Release Pin. With Quick Release Pin removed from Hinge, attached Serviceable Devices can be swung from in-work to out-of-work position upon completion of task/emergency; Ratchet-tooth Design with or without Quick Release Safety Knob Handle adjusts angle of Serviceable Device; Junction Bracket moves left/right on Adjustable Arm; Adjustable Rod moves in and out of Junction Bracket, positioning Serviceable Devices closer or further away from user. At end of Adjustable Rod is Attachment Bracket that possesses means of expeditiously attaching/securing Serviceable Devices. Second embodiment has an L-Shape design and consists of most items in first embodiment, but designed primarily for industrial/commercial and hobbyist use.

It can holding different items, i.e. Baby Bottles/Sippie Cups, attached to Baby Stroller, Car Seat, or High-Chair; Tray for toys, food, etc.; Computer Table for Laptop/Note Book; Attachment Base(s) for small devices; Single and Multi Hook-Eye, for holding infants mobile toys and tools. Both embodiments have the potential of holding numerous unmentioned items for: workers, sportsmen, hobbyist, and housewives.

### DRAWINGS—FIGURES: 1-22

FIG. 1. is an overall side view of complete Universal Holding Device Body. It shows all parts in sequence, and has an inverted U-shape appearance.

FIG. 2. shows four side views, an one projected view, i.e. one Holding Device Body,(Fixed), two Clamping Devices and one Support Bracket, Removable, and one projected view of Holding Device Body, (Fixed).

FIG. 3. shows two view, i.e. one side and one projected view of Holding Device Body, Separating with Support Bracket Removable.

FIG. 4. shows two views, i.e. one side and one projected views of Holding Device Body, Quick Adjusting.

FIG. 5. shows two views, i.e. one top and one side views of Hinge, Round.

FIG. 6. shows four views of Ratchet-tooth Device with Quick Release Safety Knob Handle, i.e. one side view, one exploded detail view, one projected view and one inside view.

FIG. 7. shows two views, i.e. one top exploded and one assembled bottom view of Adjustable Arm, Junction Bracket, and Adjustable Rod.

FIG. 8. shows two views, i.e. one side and one top projected view of Hinge Rectangular, Horizontal.

FIG. 9. shows two views, i.e. one side and one top projected view of Hinge Rectangular, Vertical.

FIG. 10. shows two views, i.e. one side and one top views of Hinge Square.

FIG. 11. shows three views, i.e. one side view of Universal Holding Device Change, and two detail side views of Ratchet-tooth Devices. It shows all parts in sequence and has an L-Shape appearance.

SERVICEABLE DEVICES: FIG. 12-22

FIG. 12. shows three views, i.e. one front, one projected, and one side view of Baby Bottle/Sippie Cup Holder

FIG. 13. shows two views, i.e. one cut-away side and one projected view of Slug, Car Seat Filler Block.

FIG. 14., shows four views, i.e. two top one projected and one front view of Trays, i.e. Square, Rectangular, and Round Arm with attachment fixtures and integrated parts, as depicted in FIG. 15.

FIG. 15., shows two views, i.e. one projected exploded view of Attachment Fixture with Round Tray and one side view of Quick Attachment Rod, Ratchet-tooth Design with Quick Release Safety Knob Handle and Arm with Attachment Fixture and Trays.

FIG. 16., shows two views, i.e. top projected and bottom view of Computer Table, Arm with attachment fixtures and integrated parts as depicted in FIG. 15.

FIG. 17., shows four views, i.e. two projected, one projected cut-away, and one top view, of Attachment Bases, i.e. Small, round with metal, Square, Rectangular and Round Arm with attachment fixtures and integrated parts as depicted, in FIG. 15.

FIG. 18., shows two views, i.e. one side and one projected view of Single Hook-Eye Device, and Multiple Hook-Eye Devices respectively.

FIG. 19., shows three views, i.e. one projected, one front, and one cut-away of Mounting Bracket.

FIG. 20., shows two views, i.e. one projected and one top of Rotating Mounting Bracket.

FIG. 21., shows one projected view of Temporary Mounting Base.

FIG. 22., shows one projected view of Wall Mounting Base.

### DRAWING FIGURES—REFERENCE NUMBERS WORKSHEET

20. Holding Device Bodies,

20.a, Fixed

20.b, Separating; 20.b.1, Bottom Section, 20.b.2, Top Section, 20.b.2.a, Pull-Pin Thumb Screw Hole, 20.b.3, Pull Pin/Thumb Screw
20.c, Quick Adjusting; 20.c.1, Quick Adjusting, Upper Bracket, 20.c.2, Quick Adjusting Lower Bracket
22. Support Bracket, Removable; 22.a, Hole, Support Bracket Device, Removable
24. Clamping Device; 24.a, Clamping Device Hole, 24.b, Knob, 24.c, Bolt, 24.d, Pressure Plate
26. Clamping Devices; 26.a, Clamping Device Hole, 26.b, Quick Adjusting Mechanical Advantage/Pistol Grip/Ratchet Bar Clamp Device, 26.b.1., Lever, 26.b.2, Release Mechanism, 26.c, Foot, 26.d., Knob, 26.e, Bolt, 26.f, Pressure Plate
28. Hinge, Round; 28.a, Bolt, 28.a.1, Bolt Hole,28.b, Nut, 28.c, Quick Release Pull-Pin, 28.c.1, Quick Release Pull-Pin Holes, 28.e, Supports
30. Ratchet-tooth Design with/without Quick Release Safety Knob Handle; 30.a, Outside Ratchet Cam, 30.b, Ratchet-teeth, 30.c, Inside Cam/Outside Quick Release Handle, 30.d, Bolt, 30.e, Nut & Washer, 30.f. Cap
32. Adjustable Arm; 32.a, Row of Adjustment Holes, 32.b, Flat Spot, 32.c, Key/Spline
34. Junction Bracket; 34.b, Pull Pin/Thumb Screws, 34.c, Key-Way 36, Adjustable Rod, 36.a. Row of Adjustment Holes, 36.b. Flat Spot, 36.c. Key
38. Attachment Bracket; 38.b, Key-Way, 38.c, Quick Release Pull-Pin, 38.c.1, Quick Release Pin Hole
40. Quick Attachment Rod; 40.a, Quick Release Pin Hole, 40.b, Key
42. Baby Bottle/Sippie Cup Holder; 42.a, Velcro
46. Slug, Car Seat Filler Block; 46.a, Car Seat/Baby Carrier
48. Tray; 48.a, Ratchet-tooth with Quick Release Safety Knob Handle, 48.b, Arm with Attachment Fixture, 48.c, Square, 48.d, Rectangular, 48.e, Round, 48.f, Cam, 48.g, Ratchet-teeth, 48.h, Quick Release Safety Handle, 48.i, Bolt, 48.j, Nut & Washer
50. Attachment Base; 50.a, Small, metal, 50.b, Square, 50.c, Rectangular, 50.d, Round, 50.f, Cam, 50.g, Ratchet-teeth
52. Mounting Bracket; 52.a. Pull-Pin/Thumb Screw Hole, 52.b. Pull-Pin/Thumb Screw, 52.c. Fastener Holes
54. Rotating Mounting Bracket; 54.a, Mounting Bracket Holes, 54.b, Lazy Susan, 54.c, Holes/Indents/Notches, 54.d, Ball and Spring Plunger/Pull Ring Spring Plunger, 54.e, Base Plate, 54.f, Pull-Pin/Thumb Screw, 54.g, Cut-out
56. Temporary Mounting Base; 56.a, Clamping Devices
58. Computer Table, (Lap Top/Note Book) 58.a, L-Bracket, 58.b, Thumb Screw/Pull Pin, 58.c, Velcro, 58.d, Vent
60. Single Hook-Eye; 60.a, Single Hook, 60.b, Single Eye
62. Multi Hook-Eye; 62.a, Hook, 62.b, Eye, 62.c, Insert Cup,
64. Arms; 64.b, Arm with Ratchet #30, 64.c, Arm with Attachment Bracket #38
66. Safety Caps
68. Wall Mounting Base
70. Hinge, Rectangular, Horizontally Mounted; 70.a, Support, 70.b, Hinge Pin, 70.c, Rest
72. Hinge, Rectangular, Vertically Mounted; 72.a, Support, 72.b, Hinge Pin, 72.c, Rest
74. Hinge, Square

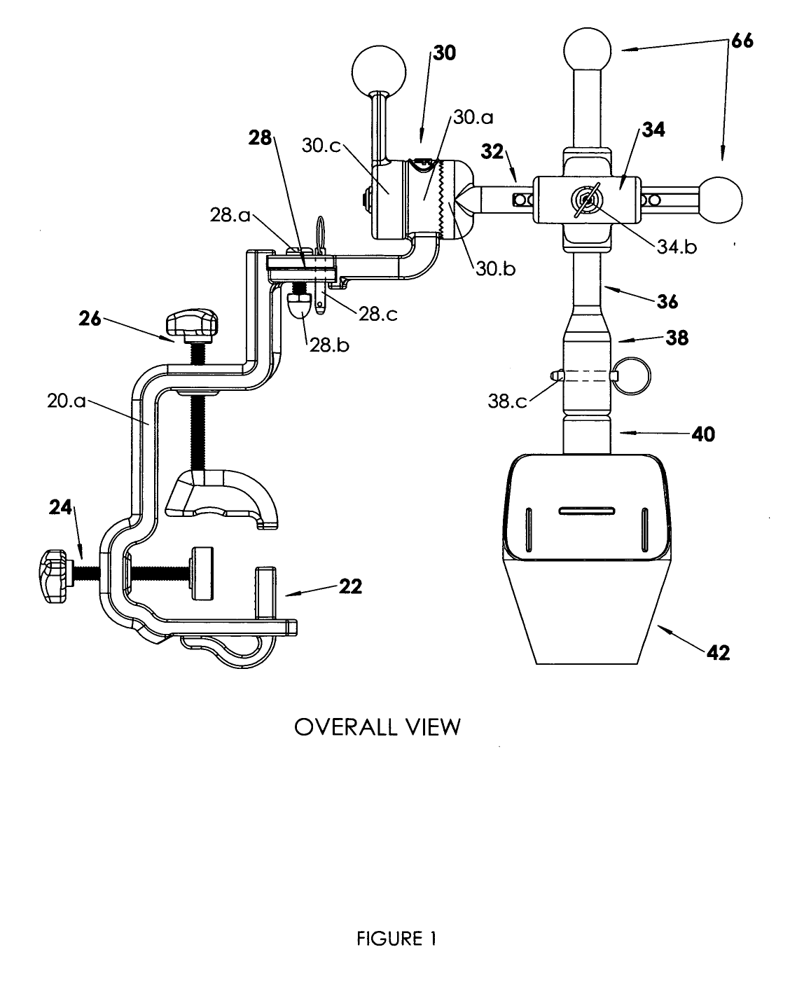

### Detail Description—First Embodiment: FIG. 1-10

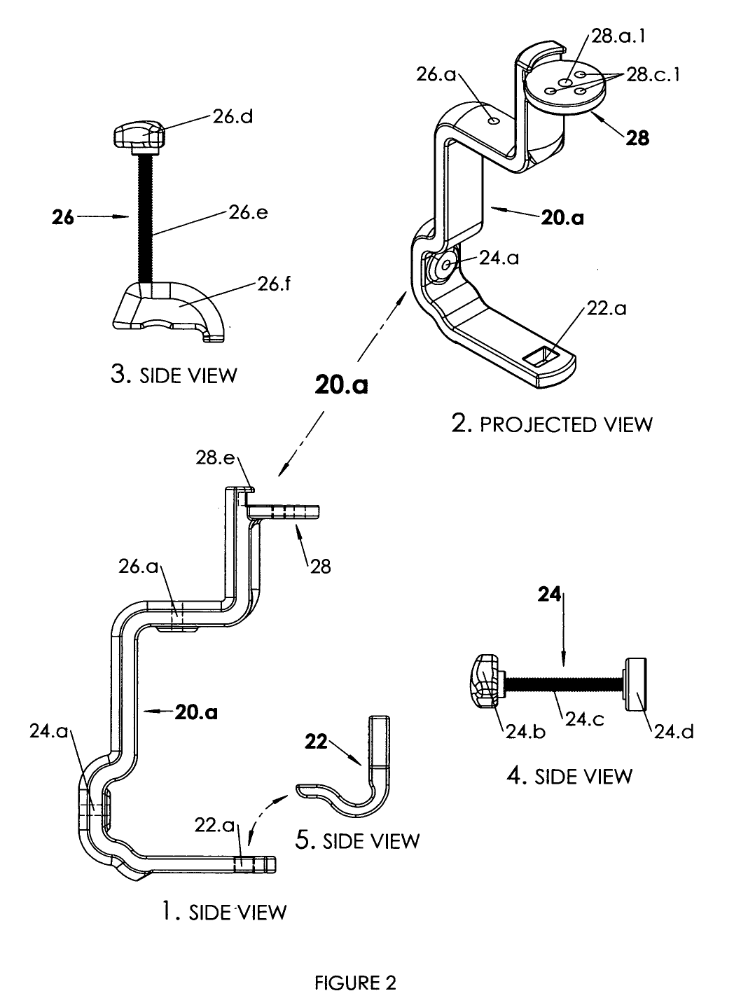

FIG. 1, shows an overall view of Universal Holding Device Body, and has appearance of an inverted U-shape. All remaining FIGS. 2 through 11 are detail drawings/upgrades that expands overall scope of FIG. 1.

Starting on left side of inverted “U” shape is, Holding Device Body, 20.a, b, or c, i.e. main limb. Moving to bottom of main limb, on far right side is Support Bracket, Removable, 22. Moving left to vertical limb, turn up to Clamping Device, 24. Continue up main vertical limb to upper horizontal limb, turn right to Clamping Device, 26. Move right, than up to top limb, integrated with Hinge, Round Lower Half, 28. On top is Hinge, Round, upper half, 28., with Bolt, 28.a., Nut.28.b., and Quick Release Pin, 28.c. Hinge Round, 28., upper half is integrated/attached on it's right side to Ratchet-tooth, 30. Ratchet-tooth, 30., is integrated/attached on it's right with Adjustable Arm 32. Moving right and resting on Adjustable Arm 32., is Junction Bracket 34. Said device is made up of two tubes, integrated, one on top of the other, forming a plus sign. Adjustable Rod 36., is inserted into other tube of Junction Bracket 34. At the lower end and integrated with Adjustable Rod, 36., is Attachment Bracket 38. Inserted into Attachment Bracket, 38., is Quick Attachment Rod 40., and held in place by Pull-Pin 38.c. Integrated with Quick Attachment Rod 40., is Baby Bottle Holder 42.

### Detail FIGS. 2-10

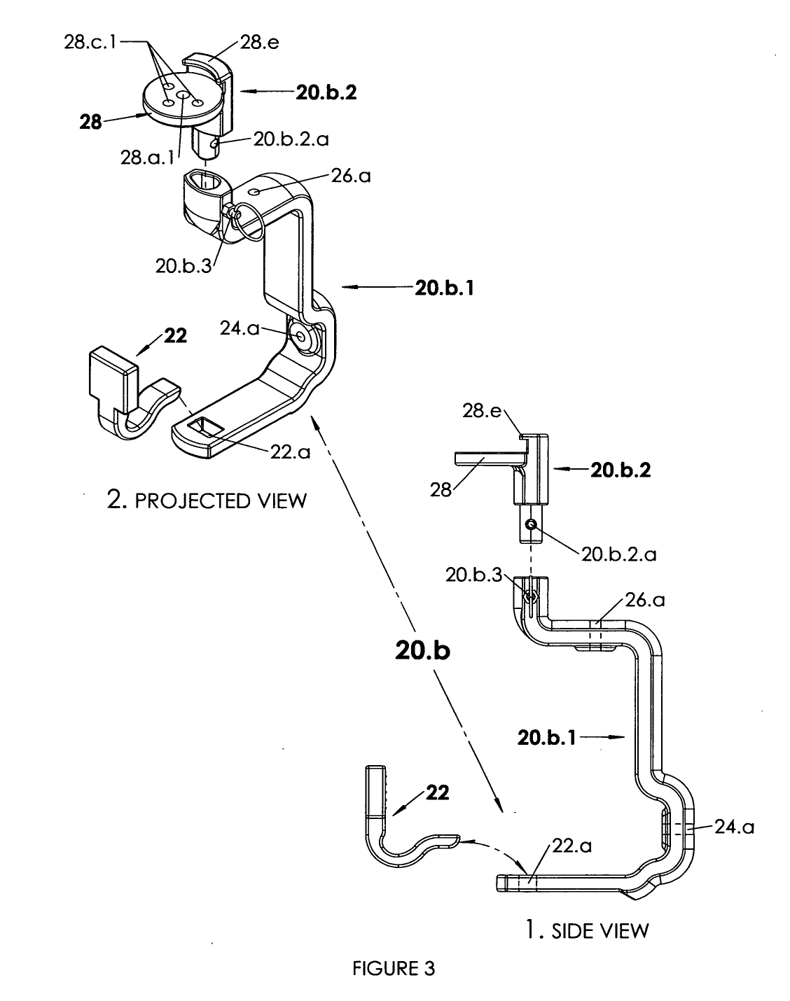

FIGS. 2, 3, & 4, are Holding Device Bodies and they all perform same function.

FIG. 2, shows four detail views, i.e. four side and one projected view of Holding Device Body, Fixed, 20.a, with main supporting body, and associated parts, are integrated with, Hinge, lower half, 28, and Support, 28.e. Other integrated/attachable support devices: Support Bracket Removable, 22., Clamping Device, 26., Knob, 26.d., Bolt, 26.e., Pressure Plate, 26.f, Clamping Device, 24, Knob, 24.b., Bolt, 24.c, Pressure Plate, 24.d., Support Bracket Removable Hole, 22.a., Clamping Device Holes, 24.a., & 26.a., Quick Release Pull-Pin Holes, 28.c.1., and Bolt Hole, 28.a.1.

FIG. 3, shows two a detail views, i.e. one side and one projected of Holding Device Body Separating, 20.b., main limb separates into two pieces, i.e. Holding Device Body Lower Limb, 20.b.1, Holding Device Body Upper Limb, 20.b.2. Said device is integrated with Hinge, lower half, 28, and Support, 28.e. Other integrated/attachable support devices: Quick Release Pull Pin Holes, 28.c.1, Bolt Hole, 28.a.1, Clamping Device Holes, 26.a., & 24.a, Pull-Pin/Thumb Screw, 20.b.3, and Pull-Pin/Thumb Screw Hole, 20.b.2.a, Support Bracket Removable, 22, and Support Bracket Removable Hole, 22.a.

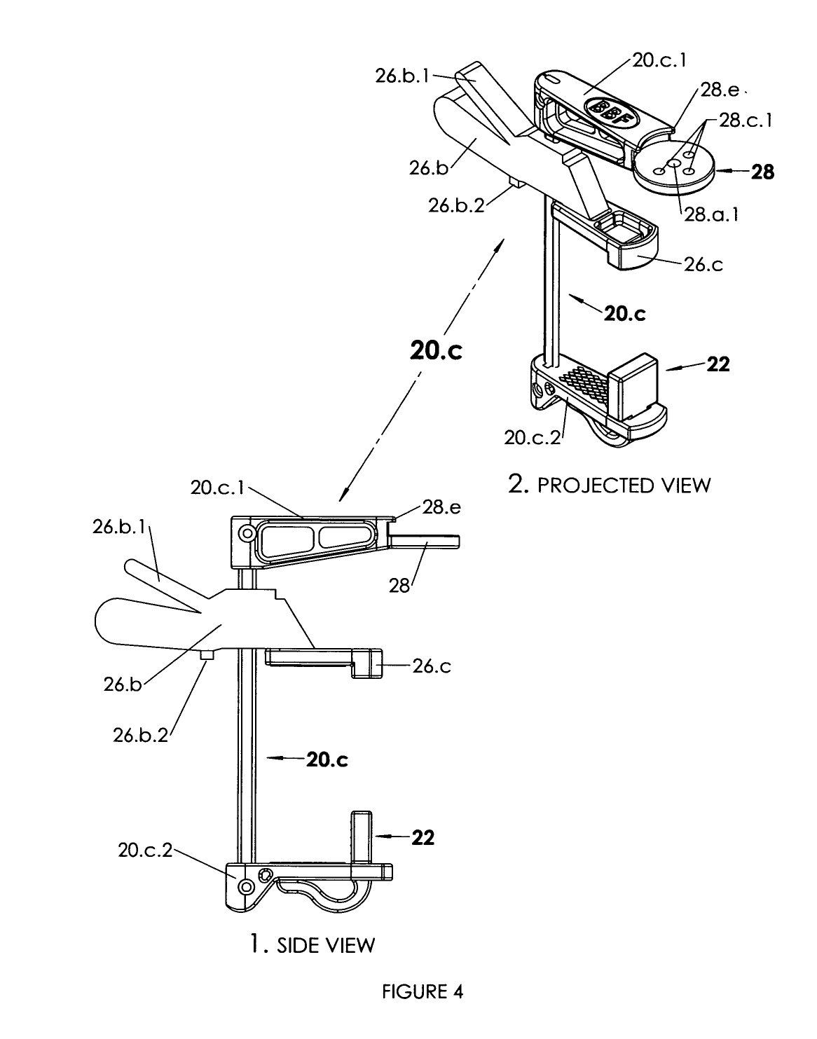

FIG. 4, shows two detail views, i.e. one side and one projected, of Holding Device Body Quick Adjusting, 20.c., main limb, and it's attached/integrated support devices, i.e. Hinge, lower half, 28., Support, 28.e., Quick Release Pull-Pin Holes, 28.c.1, Bolt Hole, 28.a.1., Quick Adjusting Upper Bracket 20.c.1., Quick Adjusting Lower Bracket, 20.c.2., Quick Adjusting Mechanical Advantage/Pistol Grip/Ratchet Bar Clamp Device, 26.b., Lever, 26.b.1., Foot, 26.c., and Support Bracket Removable, 22.

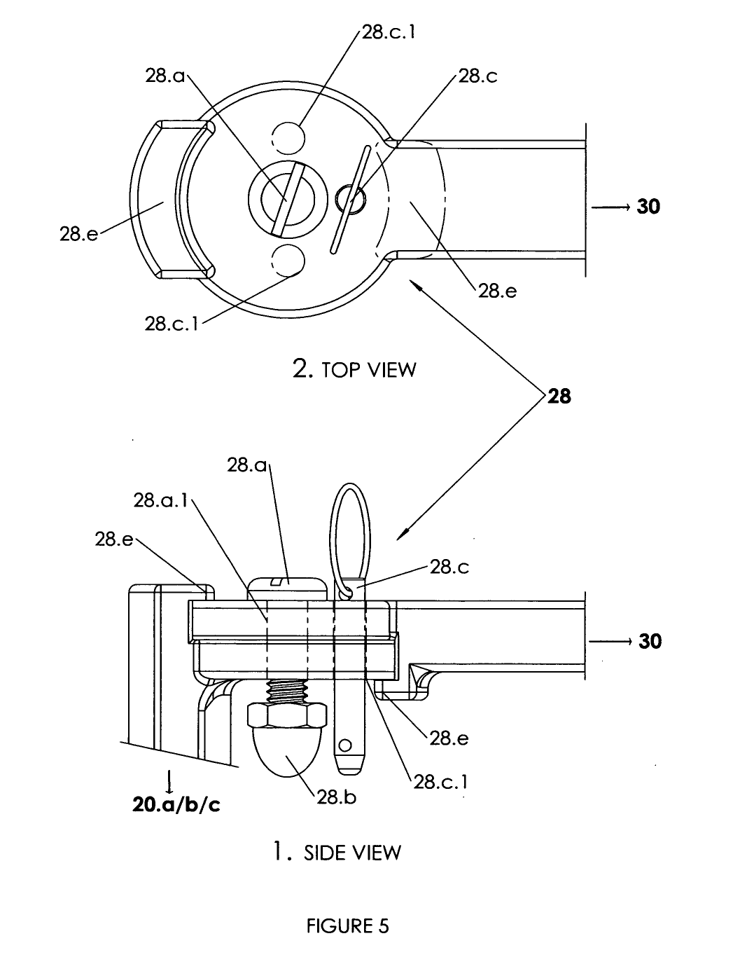

FIG. 5, shows two detail views, i.e. one top and one side, of Hinge, Round 28. Said device consists of two flat surfaces. Lower half is integrated on left-side with Holding Device Body, 20.a.,b., or c., and upper half is integrated on right-side with Ratchet-tooth, 30/64.b. Side view of said device, shows it's two flat surfaces each have one Support, 28.e., and each support extends over opposite half up/down and inward. Side view shows Bolt 28.a., Nut 28.b., Bolt Hole, 28.a.1., Pull-Pin/Quick Release Pin 28.c., and Pull-Pin/Quick Release Pin Hole, 28.c.1. Top Hinge half has one Pull-Pin/Quick Release Pin Holes, 28.c.1, and bottom Hinge half has three Pull-Pin/Quick Release Pin Holes, 28.c.1.

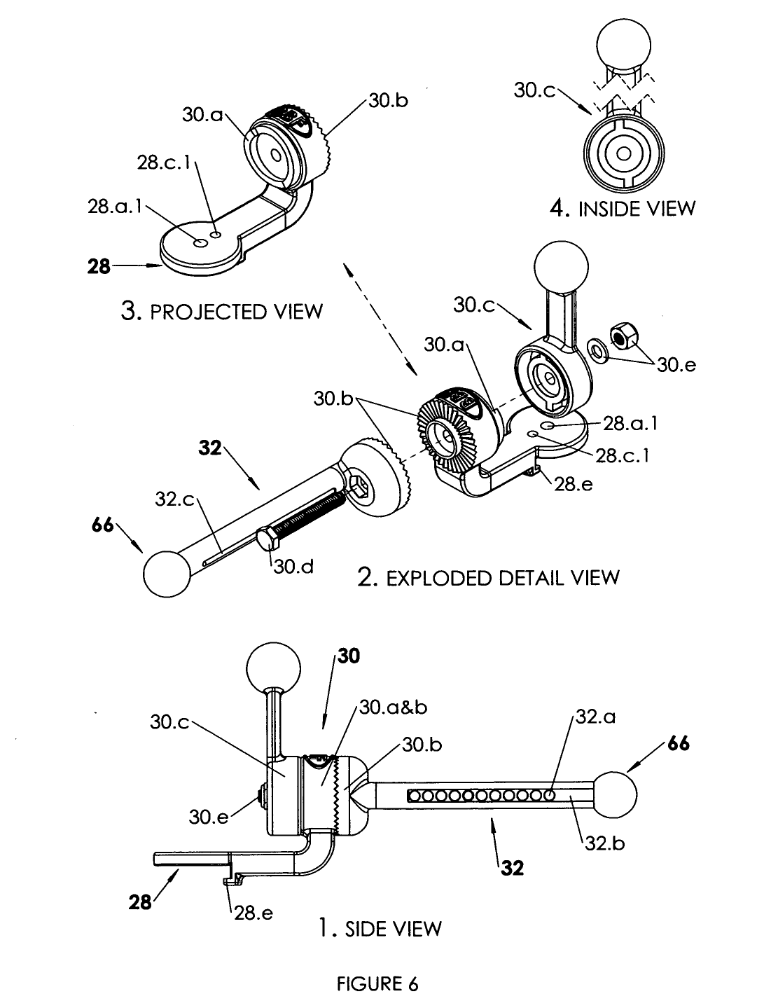

FIG. 6, shows four detail views, i.e. one side assembled, one exploded detail, one projected and one inside. Side views show parts of Upper Hinge Half, Round, 28, Ratchet-tooth 30, and Adjustable Arm 32, Row of Adjustable Holes, 32.a, Flat Spot, 32,b, with Safety Cap, 66. Exploded view shows all major parts disassembled, Ratchet-tooth Design with Quick Release Safety Knob Handle, 30, integrated on one side with Hinge(s), 28, 70., 72, or 74, is integrated on opposite side with Adjustable Arm 32, with Safety Cap, 66. Part in between are, Ratchet-teeth, 30,b, Quick Release Safety Knob Handle 30.c, Adjustable Arm 32, Spline, 32.c, Bolt, 30.d, Nut & Washer, 30.e. Projected view show same parts with a different prospective. Inside view shows Inside of Cam, 30.c, actuating mechanism.

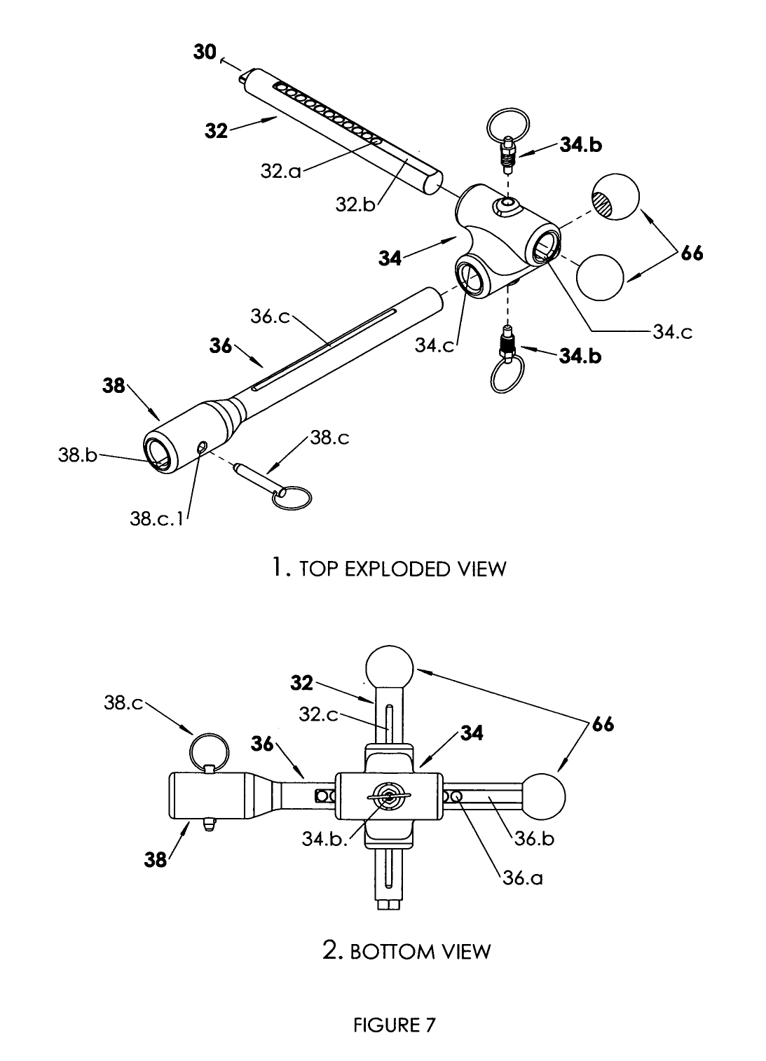

FIG. 7, shows two views, i.e. one top exploded disassembled and one bottom assembled. Exploded view shows Adjustable Arm 32., separated from Ratchet-tooth 30., of FIG. 4, Junction Bracket, 34., Adjustable Rod, 36, and Attachment Bracket, 38. On top of Adjustable Arm 32, is a row of Holes, 32.a., flat spot 32.b., Junction Bracket, 34, and at the very end is Safety Cap, 66. Junction Bracket, 34., possesses two integrated tubes, one on top of the other forming a plus sign, two Pull-Pins/Hand Knobs, 34,b., and two Key-Ways, 34.c. Other tube of Junction Bracket, 34., inline with Adjustable Rod, 36., is Safety Cap, 66. On top of Adjustable Rod 36., is Key, 36.c., and integrated at it's end is Attachment Bracket, 38. On side of Attachment Bracket, 38., is Quick Release Pin Hole, 38.c.1, Quick Release Pull-Pin, 38.c, and inside is Key-Way, 38.b. Assembled Bottom view shows all items assembled, but this view shows the opposite side, i.e. Adjustable Arm 32, with Key, 32.c., Adjustable Rod, 36., and row of Adjustment Holes, 36.a. Both Adjustable Ann and Adjustable Rod have the same features i.e. Holes, Key, and Flat Spot.

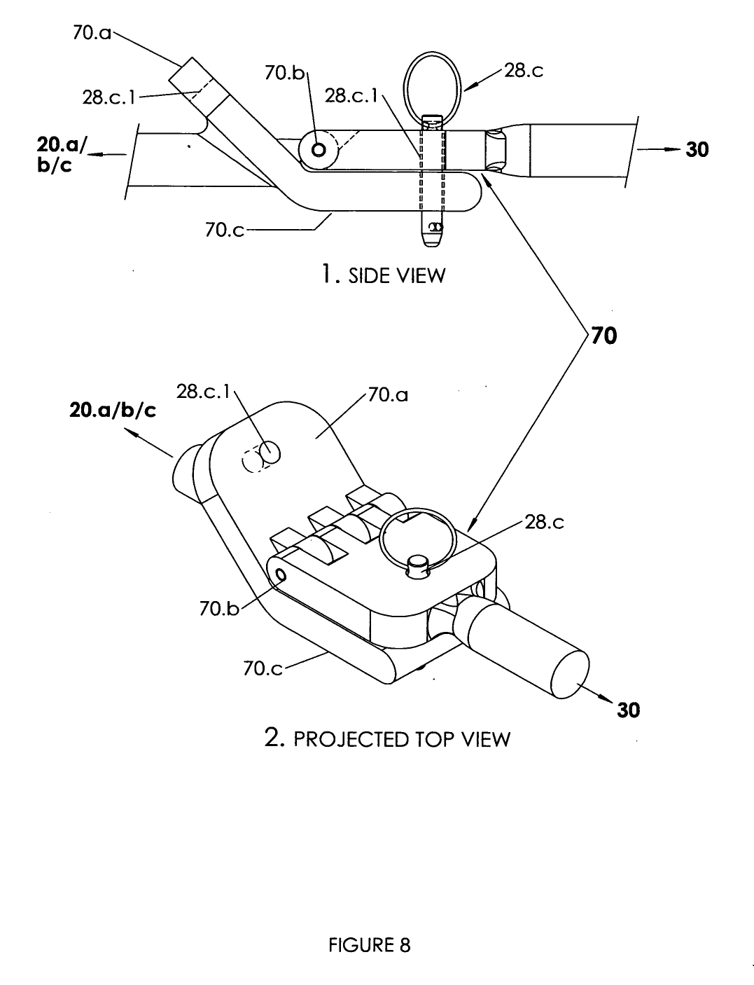

FIG. 8, shows two views, i.e. one side and one projected top of Hinge, Rectangular, Horizontally Mounted, 70. It is integrated on left side with Holding Device Bodies, 20.,a., b., or c., and on right side with Ratchet-tooth 30. Side view shows top movable part Hinge, 70., connected to stationary part by Hinge Pin 70.b. in similar manner as a common door hinge. When movable Hinge 70, is in horizontal/In-work position, it is supported by Rest 70.c, and in Out-work position it reclines against Support, 70.a. Pull Pin 28.c., is used to temporarily secure said Hinge, in both positions, vice Pull-Pin Holes, 28.c.1.

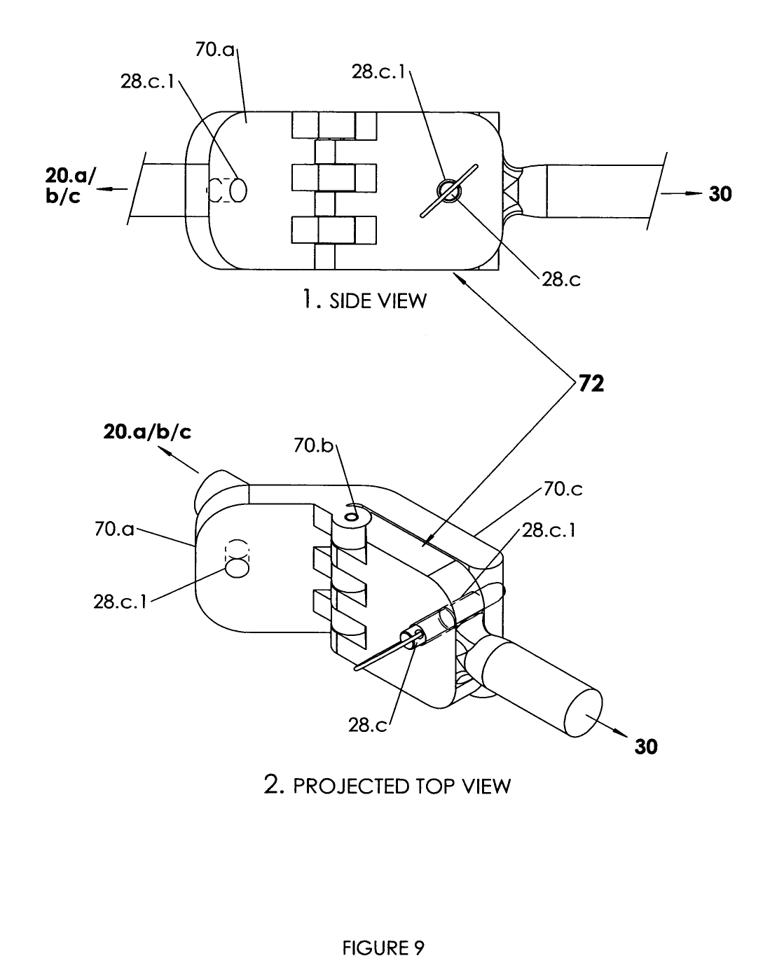

FIG. 9, shows two views, i.e. one side and one projected top of Hinge, Rectangular, Vertically Mounted, 72. This Hinge has same form, fit and function and parts as FIG. 8., but is mounted Vertically vice Horizontally.

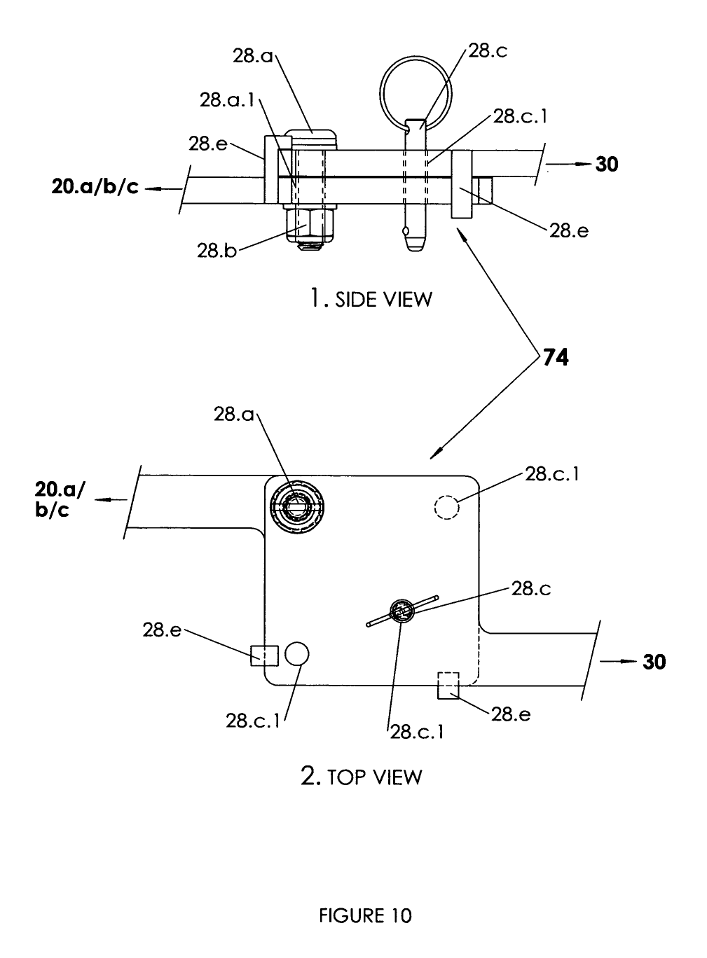

FIG. 10, shows two views, i.e. one side and one top of Hinge, Square 74. Said hinge, consists of two flat surfaces, and is similar in parts and operation as Hinge, Round 28. Hinge is integrated on left-side with Holding Device Body, 20.a.,b., or c., and integrated on right-side with Ratchet, 30. Side view of said Hinge, with it's two flat surfaces has two Support(s) 28.e., one on each half that extend over opposite half and inward. These two flat surfaces are permanently held together through Bolt Hole, 28a.1, with Bolt 28.a., Nut 28.b., and held temporarily in position with Pull-Pin/Quick Release Pin 28.c. Bottom and top halves of said Hinge, each have two Pull-Pin/Quick Release Pull-Pin Holes, 28.c.1.

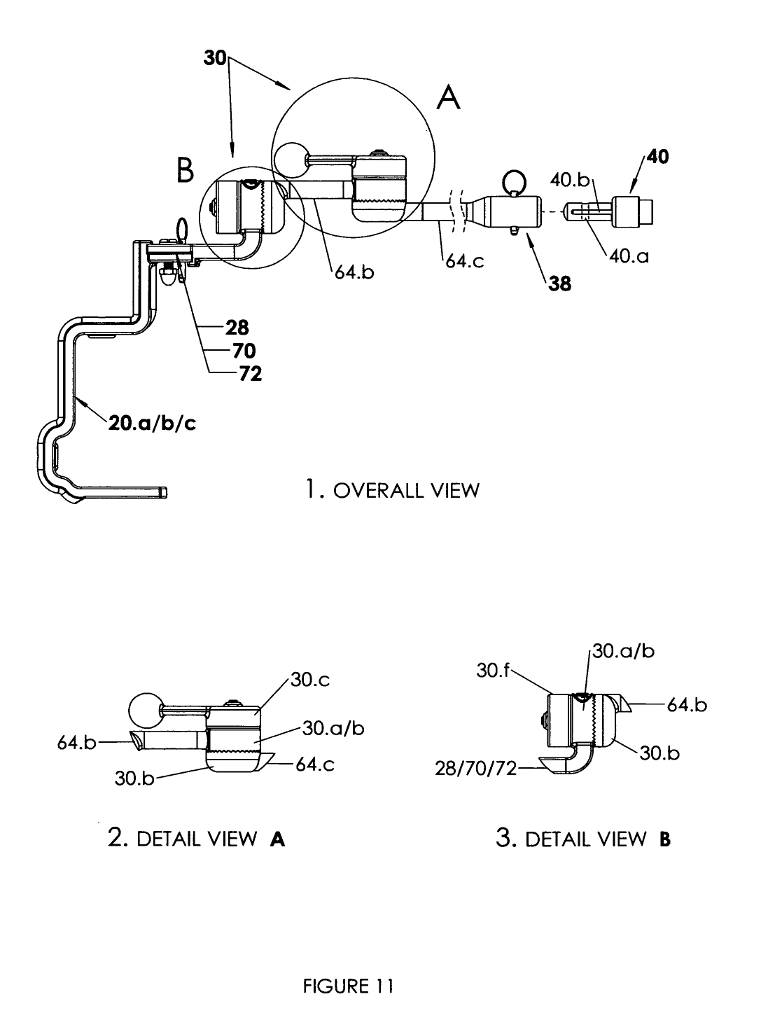

### Detail Description—Second Embodiment: FIG. 11

FIG. 11, shows three views, i.e. one overall side and two detail views of Universal Holding Device Body, Change. This is designed primarily for commercial application. It is slightly different, in that it has a L-shape appearance, but it uses only those items addressed in previous figures. It uses identical items of: Holding Device Bodies, FIG. 2, 3 or 4, Hinges, FIGS. 5, 8, & 9, and Attachment Bracket, 38. It may use regular and/or modified Ratchet-tooth's, as shown in detail view A and B, i.e. direction of integration & actuation may be different Overall view shows Hinge, 28., integrated with Ratchet-tooth, 30., integrated with Arm, 64.b., integrated with Ratchet-tooth, 30., integrated with Arm, 64.c., and integrated with Attachment Bracket, 38. Said bracket has a means to connect to Quick Attachment Rod, 40.

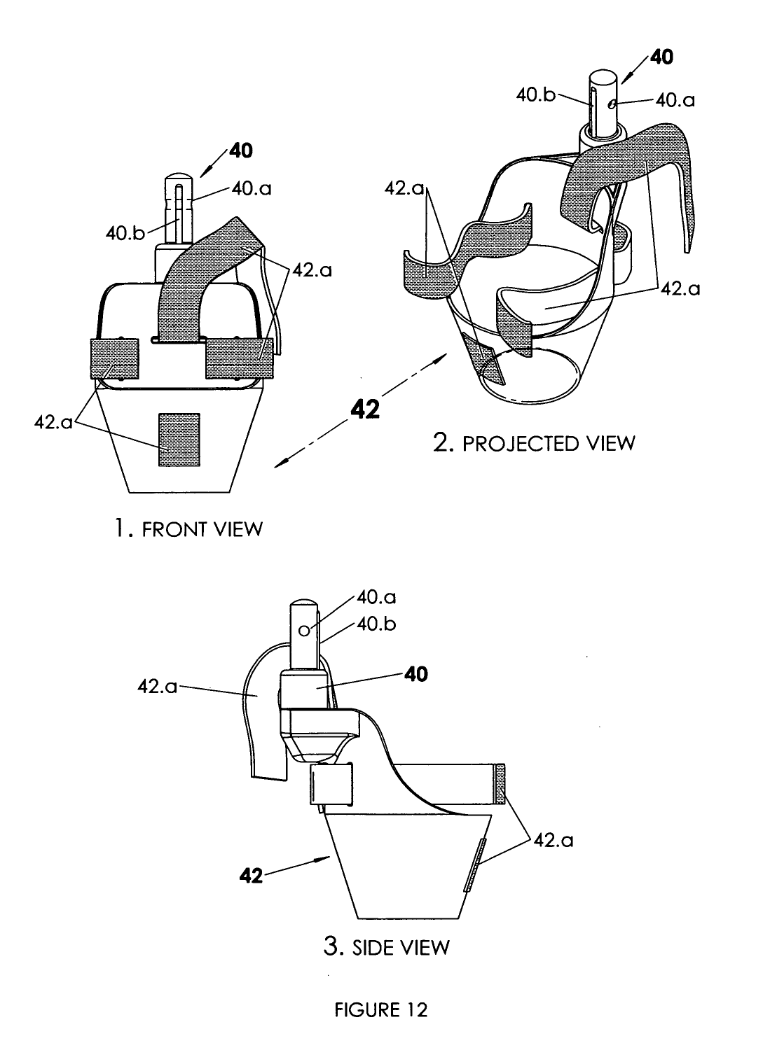

### Serviceable Devices: FIGS. 12-22

FIG. 12, shows three views, i.e. one front, one projected and one side of Baby Bottle Holder, 42., integrated with Quick Attachment Rod 40., has a Funnel Shape style with Velcro 42.a., hold down straps.

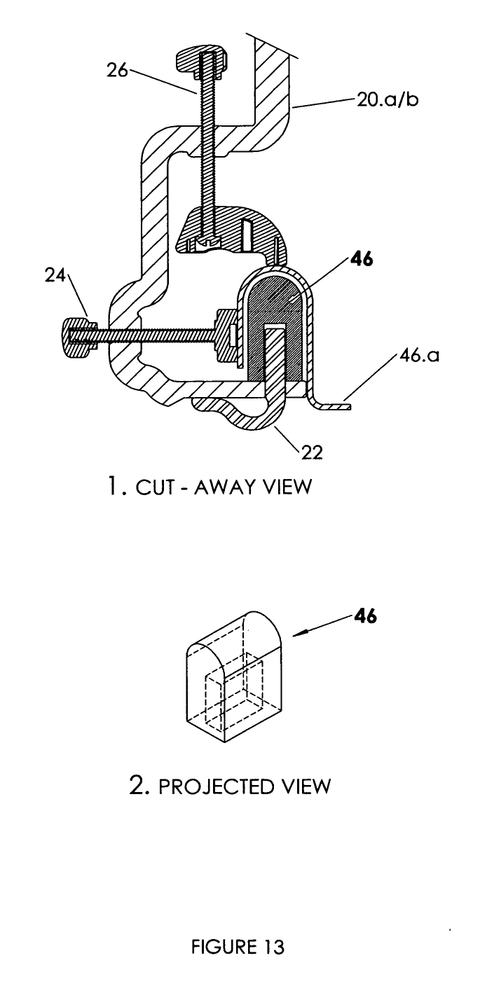

FIG. 13, shows two views, i.e. one cut-away and one projected of Slug 46., installed onto Support Bracket, Removable, 22., and positioned underneath rounded, rolled over edge of Car Seat/Baby Carrier 46.a. Clamping Devices 24., and 26., secure Slug 46., in position. Projected view shows Slug 46.

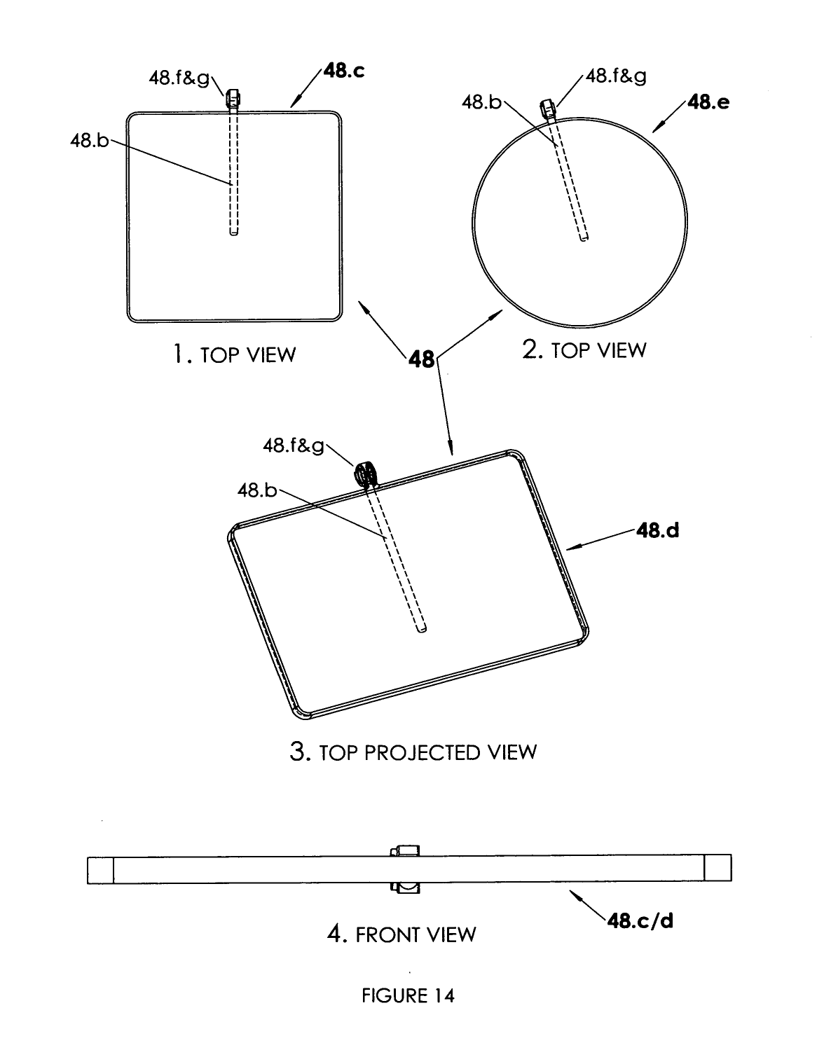

FIG. 14, shows four views, i.e. two top, one top projected, and one front of Tray 48. Each Tray possesses Arm with Attachment Fixture, 48.b, Cam 48.f, and Ratchet-teeth, 48.g.

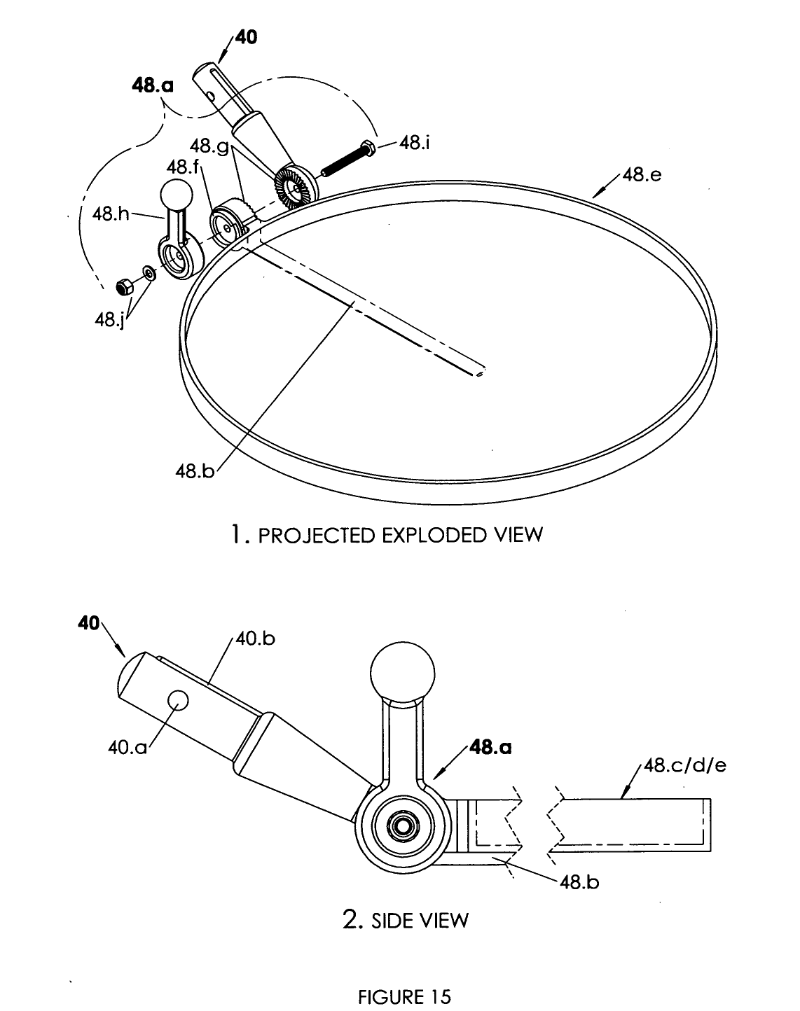

FIG. 15, shows two views, i.e. one projected exploded view of Attachment Fixture, composed of Cam, 48.f, Ratchet-teeth, 48.g, Quick Release Safety Knob Handle, 48.h, Bolt, 48.i, Nut & Washer, 48.j, with Round Tray, 48.e. One side view of Quick Attachment Rod, 40., Arm with Attachment Fixture, 48.b, and Ratchet-tooth with Quick Release Safety Knob Handle, 48.a.

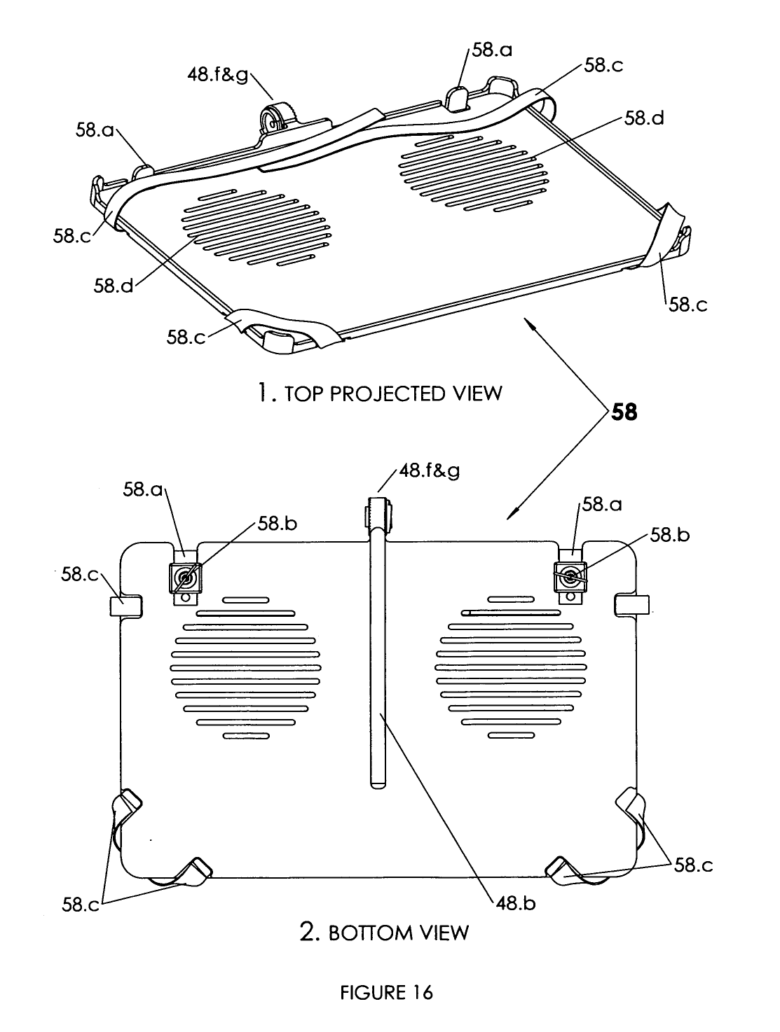

FIG. 16., shows two views, i.e. one top projected and one bottom view of Computer Table, 58., i.e. Laptop/Note Book. Said device has three Velcro securing devices, 58.c., i.e. one for each front corner, and one towards the back. Said device has two L-Brackets, 58.a., in rear, and each has a securing device, e.g. Thumb Screw/Pull-Pin, 58.b. Each view possesses, Arm with Attachment Fixture, 48.b, with Cam 48.f, and Ratchet-teeth 48.g.

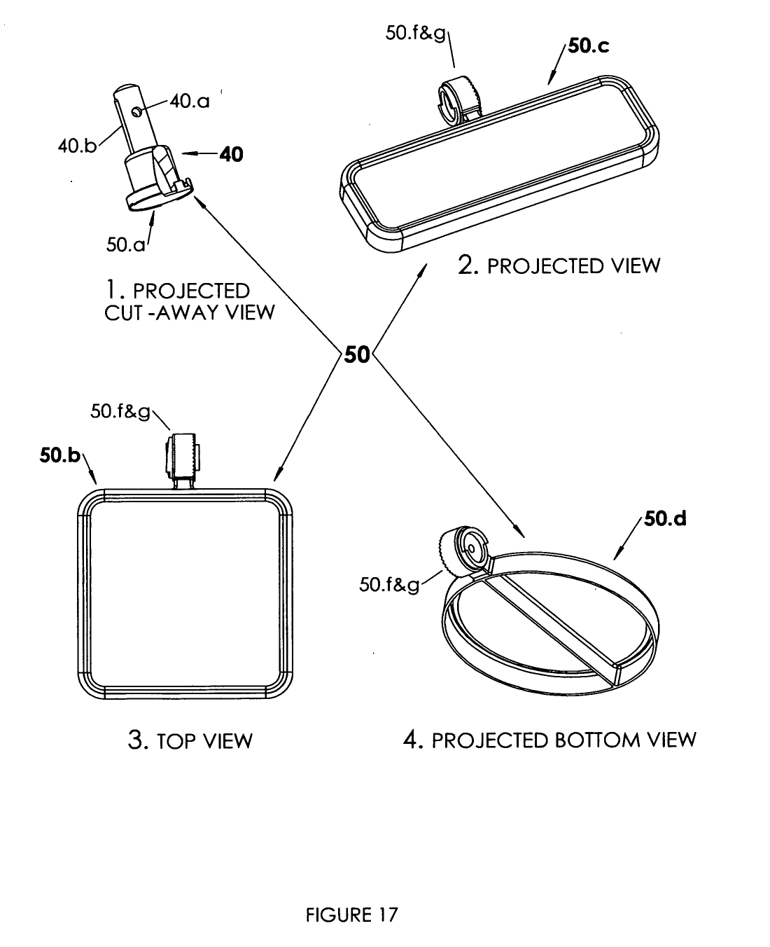

FIG. 17., shows four views, i.e. two projected, one projected cut-away, and one top of Attachment Bases, i.e. Small, with metal, 50.a, Square, 50.b, Rectangular, 50.c, and Round, 50.d, each with, Cam, 50.f, and Ratchet-teeth, 50.g, or Quick Attachment Rod, 40.

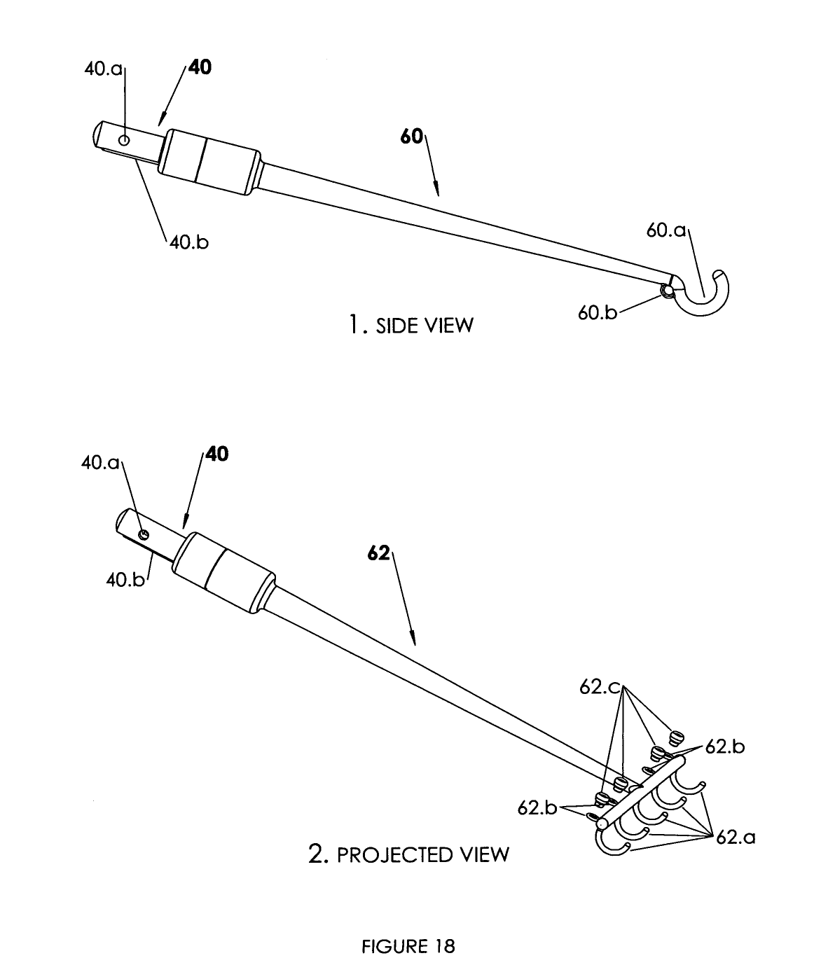

FIG. 18., shows two views, one side and one projected view of Single and Multiple Hook-Eye Devices 60., & 62. Single Hook-Eye has Hook, 60.a, Eye, 60.b. Multi-Hook-Eye, 62, has four Hooks, 62.a, four Eyes, 62.b, and four Insert Cups 62.c. Each Hook-Eye Device may be attached at the end or side of Quick Attachment Rod, 40.

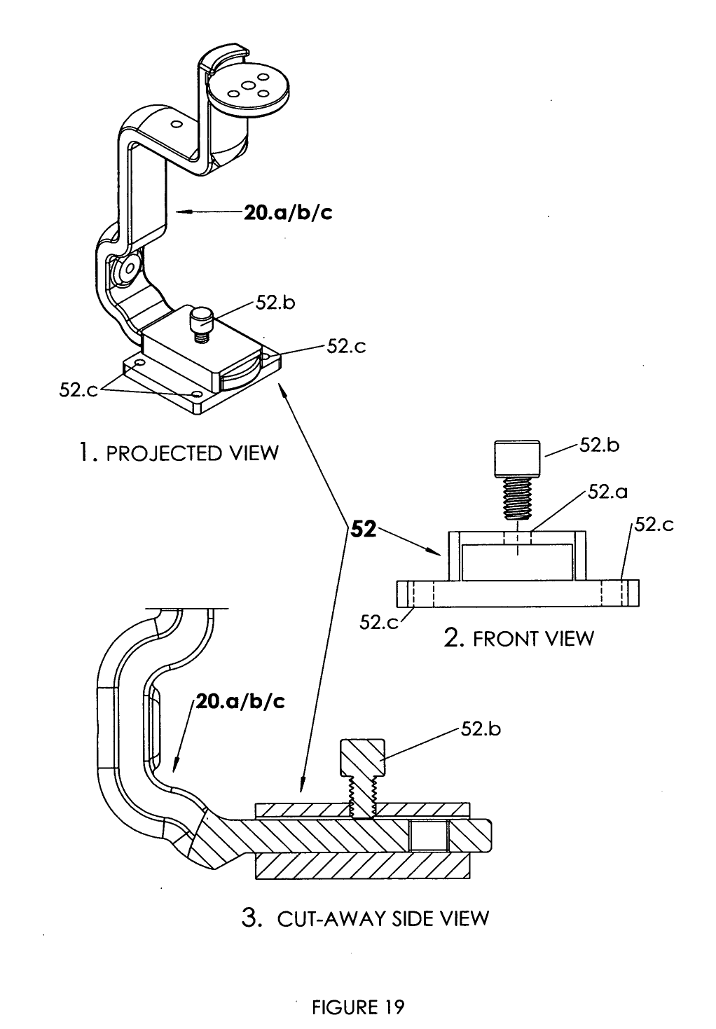

FIG. 19., shows three views, i.e. one projected, one front and one cutaway, of Mounting Bracket 52., designed to be used with Holding Device Bodies, 20.a., b., or c. It has four Mounting Fastener Holes, 52.c, one Thumb Screw/Pull-Pin 52.b, and one Pull-Pin/Thumb Screw Hole, 52.a.

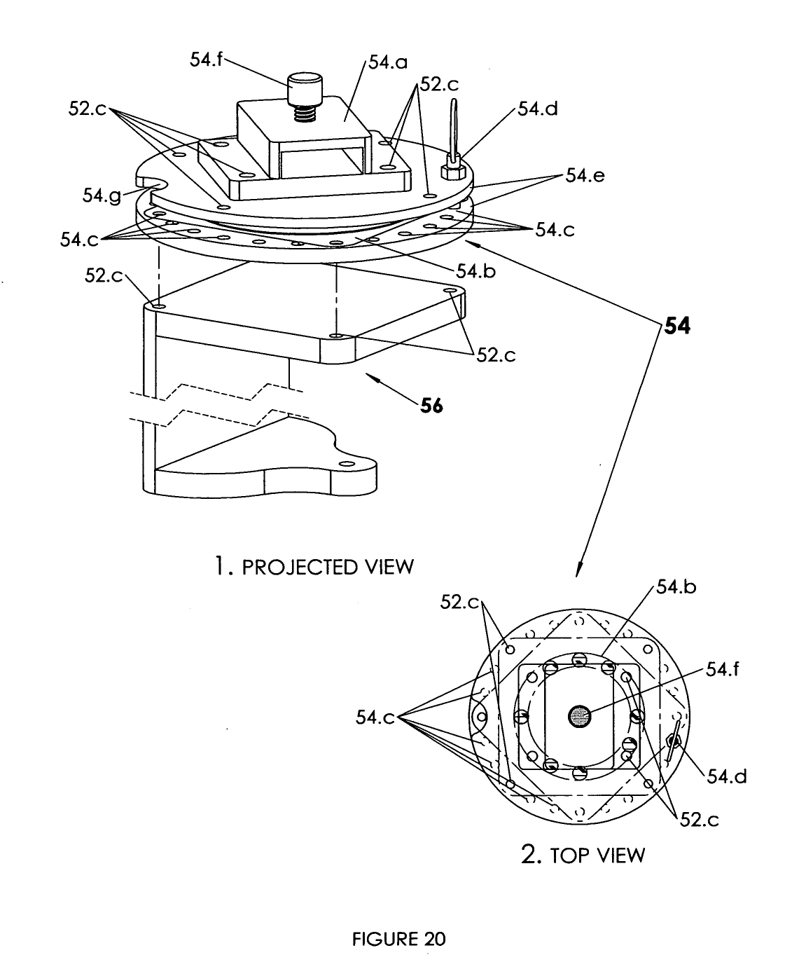

FIG. 20., shows two views of Rotating Mounting Bracket, 54. Projected view shows Mounting Bracket 54.e., with it's Holes/Indents/Notches, 54.c., Lazy Susan, 54.b., Mounting Bracket 54.a., Pull-Pin/Thumb Screw 54.f, temporary securing devices, e.g. Ball and Spring Plunger/Pull Ring Spring Plunger, 54.d, Fastener Holes, 52.c, and Cut-out, 54.g.

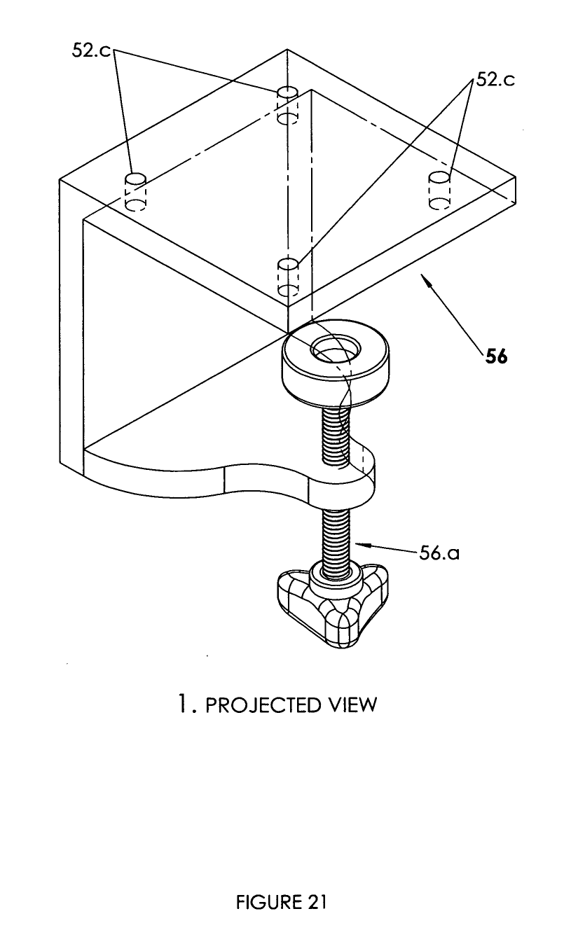

FIG. 21., shows a view of Temporary Mounting Base 56., with Thumb Screw/Securing Device, 56.a., and Mounting Holes 52.c.

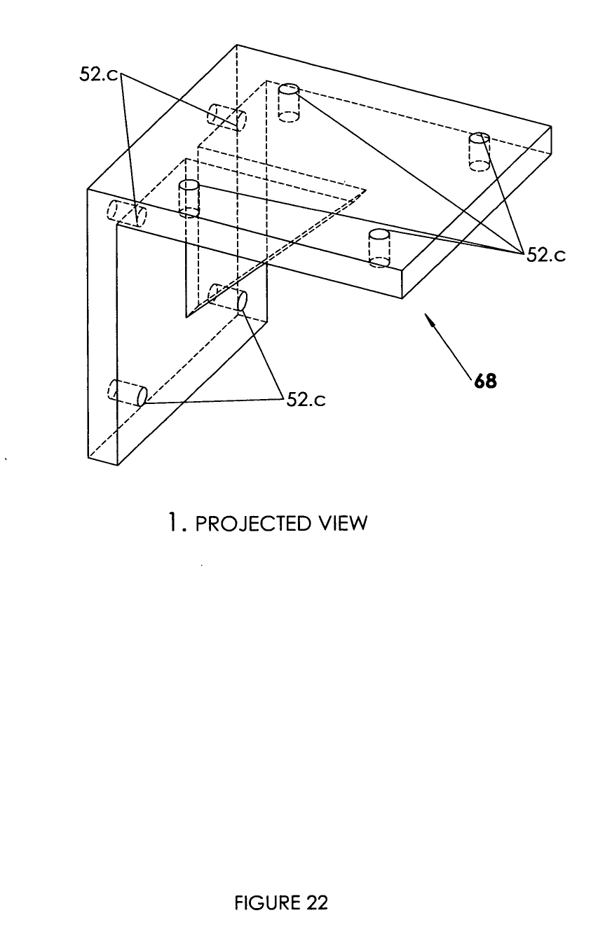

FIG. 22., shows a view of Wall Mounting Base 68., and Mounting Holes 52.c.

### Operation—First Embodiment: FIG. 1-10

First Embodiment shows an overall view of Universal Holding Device Body. It is built in an inverted U-Shape style with one of many detachable Serviceable Devices, i.e. Baby Bottle Holder, 42., ref FIG. 12 thru 22. FIG. 1., is viewed from receiving side, i.e. sitting in infant/child's stroller. Said device is available in different shapes, sizes and material, i.e. three models/weight class, e.g. light, medium, and heavy, and this provides greater range of adaptability to meet domestic or industrial requirements. FIG. 2., thru 11., are detail drawings that expands overall scope of FIG. 1.

FIG. 1, shows one overall view. It begins at Holding Device Body, 20.a., one of three types of main supporting bodies, i.e. 20.a,b, or c. Starting at Holding Device Body, 20.a, bottom/lower limb, and slightly to right is Support Bracket, Removable, 22, inserted into Hole, Support Bracket Device, Removable, 22.a, ref FIG. 2. Support Bracket Removable 22 is a quasi “L” shaped piece, i.e. vertical piece is straight, horizontal piece is question mark shaped. From here move left than up main supporting body to Clamping Device, 24. This device places horizontal pressure upon item located between it and Support Bracket, Removable, 22. Continue up to top, make right turn to Clamping Device, 26. This device places vertical pressure upon item located beneath it and small horizontal leg that holds Support Bracket Removable 22. These two Clamping Devices, 24., and 26., are designed to secure Universal Holding Device Body to a secure device/fixture. Move right and up to lower half of Hinge, Round, 28., integrated on left with Holding Device Body, 20.a, b, or c. Upper half of Hinge, Round, 28., rests on top of lower half and is secured permanently with Bolt, 28.a., and Nut, 28.b., and temporarily with Quick Release Pull-Pin, 28,c. Hinge, Round, 28 upper half is integrated on right side with, Ratchet-tooth with Quick Release Safety Knob Handle 30. Actuating of Safety Knob Handle, 30.c., allows engagement/disengagement of Ratchet-teeth, 30.a., and b., for degree of angle adjustment to Adjustable Arm, 32., Movement of Ratchet-tooth, 30, moves, Adjustable Arm, i.e. raises or lowers position of Serviceable Devices, e.g. Baby Bottle Holder, 42. Adjustable Arm 32., holds Junction Bracket 34., and allows it to move left and right. It can be secured in desired place with Thumb Screw/Pull-Pin, 34.b. Junction Bracket, 34., has appearance of two short pieces of tube, one on top of the other, forming a plus sign arrangement. Make a right turn onto other tube of Junction Bracket, 34., that holds Adjustable Rod, 36., which has identical characteristics to Adjustable Arm 32. When Adjustable Rod, 36., moves in and out of Junction Bracket, 34., it is moving Serviceable Devices, e.g. Baby Bottle/Sippie Cup Holder, 42, closer or further away from location. Integrated at far end of Adjustable Rod 36., is Attachment Bracket 38, with Quick Release Pin, 38.c. Inserted into Attachment Bracket 38., is Quick Attachment Rod 40., with Baby Bottle Holder 42, held by Quick Release Pin, 38.c. This is one example of numerous Serviceable Devices that are integrated with Quick Attachment Rod, 40. At the ends of Adjustable Arm, 32., and Adjustable Rod, 36., are Safety Caps. 66.

### Detail FIGS. 2-10

FIGS. 2, 3, & 4, show detailed views of Holding Device Bodies, that are same fit, and function, and very similar in form.

FIG. 2, shows five views, i.e. four side and one projected of Support Bracket, Removable Hole, 22.a., is visible in Lower Limb of top projected view. Side view #5 shows Support Bracket Removable, 22., is a quasi “L” shaped piece, i.e. vertical piece is straight, horizontal piece is question mark shaped. To insert, place vertical piece in horizontal position and insert question mark/quasi “L” shaped piece into opening in Support Bracket Device, Removable, Hole, 22.a, ref side view #1 and projected view #2. Raise straight piece up into vertical position. A snapping sound may occur when properly seated. Procedure for removing Support Bracket, 22., may be a two hand operation. Start by holding Universal Holding Device inverted and holding by lower limb with question mark/quasi “L” shape piece facing you, with fingers on both sides of Support Bracket Device, 22., use thumbs and press downward on bottom of question mark/quasi “L” shape until it releases. Rotate vertical arm down to meet horizontal part, i.e. Holding Device Body, 20,a, b, or c. Than lifting up on Support Bracket, Removable, 22., and remove. Vertical part of Support Bracket, Removable, 22., has shoulders, thus making horizontal/insert part smaller. Upon removing Support Bracket, Removable, 22., lower limb of three Holding Device Bodies can be inserted into Mounting Brackets, 52, and 54., of FIG. 19., and 20., respectfully and said brackets can be attached to most any solid structure, e.g. table, bench, machine, or etc. Moving left, than up main supporting body is Clamping Device, Hole, 24.a. Moving up to top and turn right is Clamping Device, Hole, 26.a. Moving right and than up to and integrated with is lower half of Hinge, Round 28, with four holes. Three holes are Quick Release Pull-Pin Holes, 28.c.1. Forth/center hole is Bolt Hole, 28.a.1. There is one view of each Clamping Device, 24., and 26, i.e. side view 3 and 4, with Knobs, 24.b, and 26.d, Bolt/Threads, 24.c, and 26.e. With clamping devices are installed in their respective holes turning of these Knobs applies tightening/loosening of pressure to/from Pressure Plate(s), 24.d., and 26.f., to lower limb of Holding Device Bodies, 20.,a, or b, and Support Bracket Device, Removable, 22.

FIG. 3, shows two views, i.e. one side and one projected view. FIG. 20.b, is identical to FIG. 20.a., except that top section item 20.b.2., separates from bottom section item 20.b.1. To detach, use Pull-Pin/Thumb Screw, 20.b.3., and lift up on top section 20.b.2. Lower part, i.e. Clamping Devices 24, and 26, remain attached while hinge and all other parts are removed. All other parts remain same as FIG. 2.

FIG. 4, shows two views, i.e. one side and one projected. It looks different from FIGS. 2, and 3, but both top and bottom devices i.e. 22., and 28., are identical. Items 20.c.1., 20.c.2., 26.b., 26.b.1., and 26.c., perform same function, as their counter parts. Quick Adjusting Mechanical Advantage Device Lever/Ratchet Bar Clamp, 26.b.1., on Quick Adjusting Mechanical Advantage Device/Ratchet Bar Clamp 26.b. when actuated, i.e. pumping action applies sufficient pressure to compensate for Clamping Devices 24, and 26. Release Mechanism 26.b.2, when actuated will release pressure and allow mechanism to be opened/closed.

FIG. 5, shows two views, i.e. one top and one side views of Hinge, Round, 28. This device is integrated on left side with Holding Device Bodies, 20.a/b/c, and is integrated on right side with Ratchet-tooth, 30. Top view of Hinge, Round, 28, shows two, Quick Release Pull-Pin Holes in bottom hinge half that aren't in use, i.e. 28.c.1, and installed is Quick Release Pull-Pin, 28.c, and one Bolt, 28.a. Side view shows upper half of Hinge, Round, 28., rests on top of lower half and is secured permanently through Bolt Hole, 28.a.1., with Bolt, 28.a., and Nut, 28.b. They are tightened, until there's only a small amount of friction when Hinge, Round, 28., is operated. Top view shows bottom hinge half has two Out-Work position Holes 28.c.1., and one In-Work position Hole 28.c.1., shown in bottom view, all for inserting Quick Release Pull-Pin 28.c. With Quick Release Pull-Pin 28.c., extracted from lower half of Hinge, Round, 28., it can rotate clock-wise or counter-clock-wise thus moving Serviceable Devices, from In-Work to Out-Work position, or vice versa and than re-secured in new position. Each half of Hinge, Round, 28., has two Supports 28.e., that reduces upward and downward pressure upon Bolting, 28a.

FIG. 6, shows four views, i.e. one side, one exploded, one projected, and one inside, These views show detail, internal, and external views, of Ratchet-tooth with Quick Release Safety Knob Handle, 30. Said device is integrated on one side with Hinge, 28., 70., 72., or 74 and on other side with Adjustable Arm, 32, or Arm with Ratchet, 64.b, of FIG. 11. Side view shows all parts of Ratchet-tooth with Quick Release Safety Knob Handle. All pieces, i.e. Ratchet 30a., b., & c., are secured with Bolt 30.d. and Nut & Washer, 30.e. It doesn't have to be disassembled/removed unless a different size/length Adjustable Arm 32., is required. Exploded and projected views of 30.b., show ratchet teeth. Exploded and projected view 30.a., shows Cam. Inside and exploded views of Inside Cam/Outside Quick Release Handle 30.c, is the operating mechanism. Actuating Ratchet-tooth with Quick Release Safety Knob Handle from closed position to open position releases pressure on a pair of Ratchet-teeth 30.b. This permits angle adjustment of, Adjustable Arm 32./64.b. To operate Ratchet-tooth, pull/push Quick Release Handle 30.c., from its 45° angle closed position to 45° angle open position. This disengagement allows opening of Ratchet-teeth, 30.b. Adjustable Arm 32./64.b., can than rotate approximately 120° up or down from center, i.e. 240° overall. This disengagement allows for Adjustable Arm, 32/64.b, to be rotated, clockwise/counterclockwise i.e. raises or lowers angle adjustment. The rotating of Adjustable Arm 32./64.b., in turn raising or lowers position of Serviceable Devices, ref. FIGS. 1, and 12 thru 22.

FIG. 7, shows two views, i.e. one top exploded and one bottom view of Adjustable Arm 32., Junction Bracket, 34, and Adjustable Rod 36. Adjustable Arm 32, is integrated with Ratchet-teeth, 30.b, ref. FIG. 6. Adjustable Arm, 32, is available in various replacement sizes/lengths/shapes to accommodate customers needs/requirements. Adjustable Arm 32., possesses a Row of Adjustment Holes, 32.a., Flat Spot. 32.b., on one side and Key, 32.c., on other side. Resting on and secured to Adjustable Arm 32., is Junction Bracket 34. Junction Bracket, 34., has appearance of two short pieces of tube, one on top of the other, forming a plus sign arrangement, and it can slide left and right on Adjustable Arm, 32. Each said tube possesses a Key-Way and Pull Pin/Thumb Screw. Key-Way, 34.c., is a mate for Key, 32.c., and this in turn aligns Adjustment Holes, 32.a, and 36.a, with Pull Pin/Thumb Screws, 34.b., that lock it in desired position. Adjustable Arm 32., maybe removed/replaced with a longer/shorter one, after Bolt, 30.d., and Nut & Washer, 30.e., of Ratchet-tooth with Quick Release Safety Knob Handle are removed, ref FIG. 6. Purpose of Adjustable Arm 32., is to hold/position Junction Bracket 34., and Adjustable Rod 36., at desired location/position to meet customer's needs/requirements. Ratchet-tooth with 30., will provide the desired angle. Adjustable Arm 32., and Adjustable Rod 34., have identical working features/operational characteristics. Adjustable Rod 36., moves in and out, thus moving Serviceable Devices closer or farther away, e.g. Baby Bottle Holder, 42., FIG. 1. Integrated at far end of Adjustable Rod 36., is Attachment Bracket 38. This too has a Key-Way, 38.b., to accept Serviceable Devices, Key for alignment. After Quick Attachment Rod, 40., ref FIG. 1., of Serviceable Devices are inserted, than Quick Release Pull-Pin, 38.c. will secure device. At the ends of Adjustable Arm, 32., and Adjustable Rod, 36., are Safety Caps. 66.

FIG. 8, shows two views, i.e. one side and one projected top of Hinge, Rectangular, Horizontal, 70., and Hinge Pin, 70.b, thwart-ship mounted. This device has similarities and operates like a door hinge. It shows a detail side and top projected views of Hinge, Rectangular, with Quick Release Pin, 28.c. It has an in-service Rest, 70.c., out-service Support, 70.a. It integrates with and has same fit and function as Hinge, Round, 28., but is intended to raise up out of the way rather than rotate on a center axis.

FIG. 9, shows two views, i.e. side and projected top, of Hinge, Rectangular, Vertically mounted Hinge, 72, and Hinge Pin, 70.b. This Hinge has same form, fit and function as FIG. 8., but is mounted Vertically vice Horizontally.

FIG. 10, shows two views, i.e. top and side of Square Hinge, 74. Said hinge possesses all same fit and function as Hinge, Round, 28. It possesses two Quick Release Pin Holes, 28.c.1, on each top and bottom hinge halves. It has an off-set of center axis permanent securing device, e.g. Bolt, 28.a, vice a center axis, but operates in exact same manner.

### Operation—Second Embodiment: FIG. 11

FIG. 11, second embodiment, shows three views, i.e. one overall of Universal Holding Device, Change, and two detail of Ratchet-tooth with/without Quick Release Safety Knob Handle. It has a L-Shape configuration, is available in different shapes, sizes and material, has three models/weight class, i.e. light, medium, and heavy, and is designed to be tailored to meet customers requirements. This is a combination of basic elements/components/characteristics presented in First Embodiment. Some devices may be used twice, some may be presented differently, and some may be attached to different devices, but only previously used, items are used here-in. However, Junction Bracket 34, and Adjustable Rod 36, are not shown being in FIG. 11. All three Holding Device Bodies, 20,a, b, or c., are used as main support. Support Bracket Device, Removable, 22., FIG. 1., may be used, but is not presented here-in. Clamping Devices, 24, 26, 26.b, Hinges, 28, 70, or 72, and Attachment Bracket, 38., all remain the same. Ratchet-tooth, 30., may look same or different, due to way it is configured, but it's operation remains same, even though integration/profile has changed. In FIG. 11.Detail View, A, Inside Cam/Outside Quick Release Handle, 30.c., is in a horizontal position, instead of vertical position as in FIG. 6. In FIGS. 5, 8, & 9, Hinges 28, 70, or 72, are integrated with, Ratchet-tooth with/without Quick Release Safety Knob Handle, 30. In FIG. 11, Detail view B, Ratchet-teeth, 30.b, is integrated with Arm with Ratchet-tooth, 64.b, on one side and integrated in Detail View A with Ratchet-teeth, 30.a/b. Next Ratchet-teeth 30.b is integrated with Arm with Attachment Bracket 64.c, and this is integrated with Attachment Bracket, 38. Lastly, Attachment Bracket, 38 has a Key-Way and Pull-Pin for housing and securing Quick Attachment Rod, 40., that has a Key 40.b, for alignment. All listed Serviceable Devices have Attachment Rod, 40, Key 40.b., for alignment and can attach to Attachment Bracket, 38. In Detail View B, Cap 30.f., replaces Ratchet-tooth Quick Release Safety Knob Handle, 30.c. Type, quantity, and directional facing of each device used will be dependent upon customer requirements. Customer may elect Ratchet-tooth without Quick Release Safety Knob Handle, and if so a wrench must be used to adjust/change desired angle. Operation and function of all these parts is same as First Embodiment FIG. 1. This system has potential to hold many more attachments.

### Serviceable Devices: FIGS. 12-22

NOTE: Below Serviceable Devices are each attached permanently at factory to a Quick Attachment Rod 40.

FIG. 12, shows three views, i.e. one front, one projected and one side of Baby Bottle/Sippie Cup Holder. It is permanently attached to Quick Attachment Rod 40. This Funnel Shape style has an appearance of three long pieces of Velcro 42.a., and tabs for securing Baby Bottle/Sippie Cup, but actually there are only two pieces of Velcro. These two pieces are attached to each other, forming a “T′ and threaded through three slots, from back side to front side. To operate, slide Baby Bottle or Sippie Cup into funnel with nipple/working end protruding through opening in funnel. Next, bring two side pieces over Baby Bottle/Sippie Cup and attach them to each other, i.e. one on top of other. Next bring third piece, that lays close to Quick Attachment Rod 40., forward over Baby Bottle/Sippie Cup Holder and attach to Velcro tab on funnel. This holds Baby Bottle/Sippie Cup into funnel shape holder.

FIG. 13, shows two views, i.e. one cut-away and one projected of Slug, 46. It is used when attaching Universal Holding Device to a Car Seat/Baby Carrier, 46.a., that has a rounded/roll over edge. Slug, 46., slips over top of Support Bracket, Removable, 22. Than Support Bracket, Removable, 22., with Slug, 46., on top, is positioned underneath and up inside lip of Car Seat/Baby Carrier, 46.a. Than secured in place with Clamping Devices, 24., and 26. Both of these should be tightened simultaneously while a slight amount of upward pressure on Holding Device Bodies, 20,a/b is maintained to insure that Slug 46., is installed/seated properly, up inside of rounded/rolled over edge.

FIG. 14, shows four views, i.e. two top, one top projected and one front of Tray, 48. Each Tray, i.e. Square, 48.c, Round, 48,e, and Rectangular, 48.d, is integrated with Arm with Attachment Fixture, 48.b, Cam, 48.f, and Ratchet-tooth, 48.g,. Said devices may be used to hold a multitude of different items (e.g. books, music; toys; food; etc.).

FIG. 15, shows two views, i.e. one projected exploded, and one side of Ratchet-tooth, 48.a, Quick Attachment Rod, 40, and Tray, Round, 48.e. Side view shows Attachment Rod, 40, Ratchet-tooth, 48.a, and Arm with Attachment Fixture 48.b. Ratchet-tooth, 48.a, is same form, fit, and function as Ratchet-tooth in FIG. 6. Ratchet-tooth, 48.a, and Attachment Fixture, 48.b, are designed for and integrated with FIGS. 14., 16., & 17.

FIG. 16, shows two views, i.e. one top projected and one bottom of Computer Table, Laptop/Note Book, 58., possessing two L-Brackets, 58.a., two securing devices, e.g. Thumb Screw/Pull-Pin, 58.b, and three Velcro straps, 58.c. Two front corner Velcro straps and one rear Velcro strap hold Laptop/Note Book from rising up. Two rear L-Brackets in rear keep it pushed forward.

FIG. 17, shows four views, i.e. two projected, one projected cut-away, and one top view, of four Attachment Bases, i.e. Small, with metal, 50.a, Square, 50.b, Rectangular, 50.c, and Round, 50.d, Attachment Bases with integrated parts, i.e. Cam, 50.f, and Ratchet-teeth, 50.g, that are part of Ratchet-tooth with Quick Release Safety Knob Handle, 48.a, and Quick Attachment Rod, 40. Attachment 50.a, may or may not have metal base that is used to attach an item that possesses magnetic base (e.g. LED light systems). Other Attachment Bases may have numerous holes per manufactures designs for attaching unmentioned items.

FIG. 18, shows two views, one side and one projected of Hook-Eye Devices, 60, 62 and Quick Attachment Rod, 40. Single Hook-Eye Device 60., has two sub-parts, Hook 60.a., Eye 60.b. Multi Hook-Eye Device 62., has three sub parts, Hook 62.a., and Eye 62.b., and insert Cup 62.c. Single Hook-Eye may be used to hold such things a Mobile to entertain a child, etc. Multi Hook-Eye may be used for holding/attach various items (e.g. Beauty Salon/Barber Shop hair dressing equipment, etc.).

Inserts 62.c., are used to accommodate small sized items that may fall through Eye, 62.b.

FIG. 19, shows three views, i.e. one projected, one front, and one cut away views of Mounting Bracket 52. It is designed to hold Holding Device Bodies, 20.a, b, or c. Said device can be attached by using multiple types of fasteners, e.g. rivets, sheet metal/machine screws, or bolts and nuts to any secure object that is suitable, e.g. wood, metal, plastics. After it is mounted with proper fasteners, using Fastener Holes, 52.c, said Holding Device Bodies 20.a, b, or c, can be attached. Said devices can slide into opening and tightened with Thumb Screw/Pull-Pin, 52.b. This device can also be mounted onto Temporary Mounting Bracket 56., Ref. FIG. 21. and/or Wall Mounting Bracket 68., Ref FIG. 22.

FIG. 20, shows two views, i.e. one top and one projected of Rotating Mounting Bracket 54. Mounting Bracket, 54.a., is same in form, fit, and function as Mounting Bracket 52. Said device is designed to be used with Holding Device Bodies 20.a., b., & c. Said device is secured to top half of Base, 54.e, and Lazy Susan, 54.b, is sandwiched/attached to upper and lower halves of Base, 54.e. Mounting Bracket, 54.a., rotates 360° via Lacy Susan 54.b., and temporarily secured by Ball and Spring Plunger/Hand Retractable Spring Plunger/Pull Ring Spring Plunger 54.d., which locks into Holes/Indents/Notches 54.c, to temporarily secure Rotating Bracket 54.a. Lazy Susan, 54.b, and Base, 54.e, can be attached to permanent fixture or Mounting Brackets, 56, and 68, via Mounting Fasteners Holes 52.c.

FIG. 21, shows one projected view of Temporary Mounting Base 56, with Thumb Screw/Securing Device, 56.a., and Mounting Holes 52.c. Said device is an intermediate device for temporarily attaching Mounting Bracket, 52, and Rotating Mounting Bracket, 54, to any stable item with Securing Device, 56.a, e.g. desk, table, bench, or machine. For-mentioned devices, in FIGS. 19., & 20., are made to attach hereto.

FIG. 22, shows one projected view of Wall Mounting Base 68, and Mounting Holes 52.c. Said device is a intermediate device suitable for attaching Mounting Bracket, 52, and Rotating Mounting Bracket, 54, and than be permanently secured, e.g. using proper fasteners to any stable item.

### Specifications:

### Material:

Light, Medium & Heavy, weight Universal Holding Devices: (e.g. Plastic, Nylon, PVC, Carbon-fiber, Aluminum, Steel), Embodiment 1., & 2., FIG. 1. & 8.
Note: All Materials are based upon comparable materials for applicable markets.
Conditions considered are:
   Safety (e.g. Strength/Impact Resistant/Operating)
   Sanitary (e.g. child care/nursing care)

### Dimensions:

Light weight Applications:
Only defined service dimensions are for a light weight Universal Holding Device, embodiment. It must be able to attach to a Child's Stroller, Side Bar and hold a Baby Bottle Holder and meet these requirements.
When attached to Side Bar it must have a:
   Width Reach from outside into center of stroller of approximately: 7″
   Height Reach: distance above baby, Sufficient to Operate Safely
   Thickness of Side Bar: minimum Thickness, approximately Two Inches (2″)
   Depth of Reach: approximately Three & One Half Inches (3½″)
   Note: All dimensions are based upon survey by inventor.
Medium and Heavy Applications:
Universal Holding Device, embodiment 1. & 2.
   Half Width: *
   Tray Thickness: *
   Height: *
* Similar shape as present embodiments, but may be tailored to meet markets/customer's needs/requirements, while utilizing only the elements presented here-in.

### Conclusion, Ramifications, and Scope:

Accordingly reader has seen that there are two embodiments, by using same parts but configured with slightly different variations:

Overall view shows all of Universal Holding Devices parts: i.e. Holding Device Bodies, are main support; Support Bracket, is inserted at lower limb of Holding Device Bodies, and holds items in place while pressure is being applied or if removed it allows Holding Device Bodies to be attached to Mounting Bracket, Clamping Devices, are mounted in Holding Device Bodies, and are used to clamp on to a stable fixture by applying pressure; Hinges, allows easy of movement for serviceable items from In-Work position to Out-Work position; Ratchet-tooth, allows for ease of movement angle adjustment; Adjustable Arm, allows for ease of through Junction Bracket to rest on and have left or right movement. Said device holds and permits in-out movement of Adjustable Rod, and at far end is Attachment Bracket, that has means for fast, easy attachment of serviceable devices.

Universal Holding Devices are designed for light, medium and heavy weight application. Said device will configured to meet customers needs and will be made into different types of material, i.e. Plastic (e.g. PVC, Nylon, Carbon fiber) Aluminum, Steel, to meet its service requirements for hobbyist and commercial applications.

Universal Holding Device has enormous versatility because of its different features. It is a labor saving device, designed for household, hobbyist, and industrial use. At present there are five different Serviceable Devices that expand its uses, with more to be added, i.e. Baby Bottle/Sippie Cup Holder that can be attached to: Stroller, High Chair, Crib, and Car Seat. Hook & Eye device to hold a child's mobile or tools, Tray, and Computer Table, i.e. Lap Top/Note Book, plus Attachment Base for LED Work Light.

NOTE: While above description contains many specifications, these should not be constructed as limitations, but as exemplifications. Scope of this invention should be determined by the appended claims and their legal equivalents, and not by the examples given.

### Glossary

Adjustable Arm, 32., FIG. 5.
Adjustable Rod, 36., FIG. 5.
Arms, 64.a., b., & c., FIG. 8
Arm & Attachment Fixture, 48.b, FIG. 11.a & 12.a
Attachment Base, 50.a, b, c & d, FIG. 13.
Attachment Bracket, 38., FIG. 5.
Baby Bottle Holder/Sippie Cup Holder, 42., FIG. 9.
Ball & Spring Plunger/Pull Ring Spring Plunger, 54.d., FIG. 16.
Bolt, 24.c, 26.e, 28.a. & 30.d, FIG. 3, 4 & 7
Bolt Hole 28.a.1, FIGS. 2.a, b, & c, 3 & 7
Cap, 30.f., FIG. 8.
Car Seat/Baby Carrier, 46.a FIG. 10
Clamping Device, 24., & 26., & 26.b., 56.a, FIGS. 1., 2.c. & 17
Computer Table, 58., FIG. 12.
Cut-out, 54.g, FIG. 20
Fastener, 52.a., FIGS. 15, 16 & 18
Fastener Hole, 52.c, FIGS. 15, 17 & 18
Flat Spot, 332.b. 7 36.b., FIG. 5.
Hinge Pin, 70.c & 72.c, FIGS. 6 & 6.a.
Hinge, Round, 28.,FIG. 3.
Hinge, Rectangular, Horizontal/Vertical, 70, & 72, FIGS. 6 & 6.a
Hinge, Square, 74., FIG. 7.
Holding Device Body,(Fixed) 20.a., FIG. 2.a.
Holding Device Body, (Separating)20.b., FIG. 2.b.
Holding Device Body, (Quick Adjusting) 20.c., FIG. 2.c.
Holes, Row of Adjustment, 32.a. 36.a. & 54.c, FIG. 5.
Hole, Support Bracket, 22.a., FIGS. 2.a., & b.
Insert Cup, 62.c, FIG. 14
Junction Bracket, 34., FIG. 5.
Junction Bracket, Key-Way, 34.c., FIG. 5
Junction Bracket, Pull-Pin/Thumb Screw, 34.b., FIG. 5.
L-Bracket, 58.a., FIG. 12
Lazy Susan, 54.b, FIG. 16
Mounting Bracket, 52. & 54.a., FIGS. 15. & 16
Multi Hook-Eye, 62., FIG. 14
Nut, 28.b. & 30.e FIGS. 3, 4, 6, & 7.
Pull-Pin/Thumb Screw, 20.b.3., 34.b., 52.b., 54.f., & 58.b FIGS. 2.b., 5., 12, 15., & 16.
Pull-Pin/Thumb Screw Hole, 52.a, FIG. 11, 16, & 19.
Quick Adjusting Pull-Pin/Thumb Screw, 20.b.3., FIG. 20.b.
Quick Attachment Rod, 40., FIGS. 9 & 14
Quick Release Pin, 28.c, & 38.b & c., FIG. 3, & 5.
Quick Release Pin Hole, 28.c.1, 38.c., 40.a, FIGS. 2.a, b, & c, 3, 5, 6, 7, 9, 11.a, 12.a, 13 & 14
Key, 32.c., & 36.c., FIG. 5.
Key-Way, 34.c. & 38.b., FIG. 5.
Ratchet-tooth, 48.a, FIGS. 11.a, & 12.a
Ratchet-tooth with Quick Release Safety Knob Handle, 30., FIG. 4.
Release Mechanism, 26.b.a, FIG. 4.
Rotating Mounting Bracket, 54.,FIG. 16.
Safety Caps, 66., FIG. 5.
Single Hook-Eye, 60., FIG. 14.
Slug, 46., FIG. 10.
Support, 70.a & 72.a, FIGS. 6 & 6.a
Support Bracket, Removable, 22., FIG. 2.a. & 2.c.
Temporary Mounting Bracket, 56., FIG. 17
Tray, 48.b, c, d, FIG. 11.
U-Bracket, 58.c, FIG. 12
Wall Mounting Bracket, 68., Fig.
Velcro, 42.a., FIG. 9.

What is claimed as new and what is desired to secure by Letters Patent of United States is:

1. A Universal Holding Device, Adjustable. Said claim is a labor saving, task oriented device. It is designed to interface with numerous changeable Serviceable Devices, listed in claim 35, (a) thru (j). Said claim has one basic design, two styles/types, three models and three weight classes, i.e. light, medium, and heavy. Said device has means of being configured to customers' domestic and commercial requirements using only the devices/apparatus presented here-in. Said primary Claim has an inverted U-shape. At attachment end is/are Clamping Devices and Support Bracket, Removable. At opposite end of inverted U-shaped device is Attachment Bracket that is designed to expeditiously attach multiple types of Serviceable Device(s). Said claims' primary devices are integrated with each other in sequence as presented and are composed of: Holding Device Body, Hinge, Ratchet-tooth Design with or without Quick Release Safety Knob Handle, Adjustable Arm, Junction Bracket, Adjustable Rod, and Attachment Bracket.

2. Claim 1 has three different types of Holding Device Bodies, i.e. Fixed, Separating and Quick Adjusting. Holding Device Bodies have a quasi C-shape appearance when detached from upper Hinge half, and in a vertical position and are integrated at the top part of C-shape with lower Hinge half. When viewing Holding Device Bodies attached fixtures from top down, devices are: Lower Hinge Half, Clamping Devices, and Support Bracket, Removable.

3. One of claim 2, Holding Device Bodies possesses means of separating just below lower hinge half, by removing temporary locking device. With locking device removed, entire Hinge and all attached devices can be removed while, Holding Device Body, with Clamping Devices, and Support Bracket, Removable, remains attached to a secure fixture/bracket.

4. Claim 2 has several styles of Clamping devices, screw type, i.e. custom and commercial types, tailored mechanical advantage/bar ratchet clamp type. Clamping devices have means of applying vertical/horizontal pressure to, secure fixtures. Said devices are used for attaching claim 1 to a variety of different temporary and or permanent devices, and fixtures.

5. Claim 2, Support Bracket, Removable, has means of attaching to lower horizontal limb of Holding Device Body, and is used in conjunction with horizontal clamping device.

6. Claim 5 is a removable quasi L-shaped fixture. Lower horizontal leg of said fixture possesses a quasi question mark-?-shape when installed and in a horizontal plane. Said device may possess a snapping noise when it is seated. Said device has means of assisting clamping device in restraining the fixture being clamped.

7. Claim 5 uses a special filler style/type Slug Device with means of covering vertical protrusion to facilitate claim 1, when it is being attached to a infant car seat.

8. Claim 1 may use one of four styles/types of Hinges, i.e. claim 8, 11, 14, & 17, that are integrated on one side with Holding Device Body and on other side with Ratchet-tooth with or without Quick Release Safety Knob Handle. claim 8, Hinge is positioned on a horizontal plane and possesses a center axis, with means of permanently securing, two halves. Top half possesses means of pivoting while permanently secured to lower half and while lower half remains fixed. Its two halves has means to operate and integrate with other devices, i.e. all stationary hinge halves are integrated with claim 2 and all movable hinge halves are integrated with claim 19.

9. Claim 8 possesses temporary locking device with means of locking/unlocking. Unlocking said device permits means of moving/pivoting of top half in both directions, i.e. rotate clockwise and or counter clockwise while being supported by bottom half. Said movement possesses means of moving attached Serviceable Device from its In-Work position to it's Out-Work position. Said device has means of temporarily locking device in new position.

10. Claim 8 has two L-shape flange support devices, one is integrated with top half and one is integrated with bottom half. Top L-shape flange support possesses means to reduce downward pressure upon permanent securing device. Bottom L-shape flange support possesses means to reduce upward pressure upon permanent securing device.

11. Claim 11 Hinge, is positioned on a horizontal plane and possesses a thwart-ship mounting of hinge and hinge pin, which provides means of permanently securing, operating and integrating with other devices. Said device possesses a means of temporarily securing said device upper half to said device lower half and/or upper permanent support.

12. Claim 11 rests on a horizontal plane support with means of being temporarily secured when at in-work-position and rests on vertical aft facing incline with means of being temporarily secured when at out-work-position.

13. Claim 11 fixed hinge half is integrated with Holding Device body and movable hinge half is in integrated with Ratchet-tooth Design with or without Quick Release Safety Knob Handle.

14. Claim 14 is an alternate hinge that is similar to claim 8. Said claim is integrated and positioned on a horizontal plane in same manner as claim 8, but possesses an off-center axis. It possesses a means of permanently securing two hinge halves, but providing means of allowing upper half to pivot on lower half while lower half remains fixed.

15. Claim 14, possesses temporary locking device with means of locking/unlocking device. Temporarily unlocking said device permits means of moving/pivoting top half in both directions, i.e. rotate clockwise and or counter clockwise while being supported by bottom half. Said movement has means of moving attached Serviceable Device from its In-Work position to it's Out-Work position. Said device has means of temporarily locking device in new position.

16. Claim 14, like claim 8 has two L-shape flange support devices, one on top half and one on bottom half. Top L-shape flange support possesses means to reduce downward pressure upon permanent securing device. Bottom L-shape flange support possesses means to reduce upward pressure upon permanent securing device.

17. Claim 17 is an alternate Hinge that is similar to claim 11, in operation design and integration. It possesses a hinge and hinge pin that are mounted on a vertical plane that provides means of permanently and temporarily securing, for operating and integrating with other devices. Said device is equipped with a permanent and temporary securing means.

18. Claim 17 rests against and is temporarily secured to a vertical parallel fixture when at in-work-position and rests against and temporarily secured to an aft facing vertically angled fixture when at out-work-position.

19. Claim 1 possesses Ratchet-tooth Design, with or without Quick Release Safety Knob Handle. Said device incorporates a pair of gear type teeth and a cm device held together with a securing device. When said handle is actuated it rotates against a cam device which in-turn relives pressure and permits opening and closing a pair of gear type teeth, intermeshed and held in operating position.

20. Claim 19 is integrated with a hinge on one side and claim 21 on other side. Moving of gear teeth possesses a means of changing angle adjustment of integrated Adjustable Arm of claim 21 and Serviceable Devices, of claims 35, (a) thru (j).

21. Claim 1, Adjustable Arm Device, is integrated on one side with claim 19 and has means to support and position claim 23.

22. Claim 21, is a long device that possesses a row of Holes for adjustment, a flat spot on top that extends the length of said device. On opposite side is Key, for alignment with claim 23, Key-way

23. Claim 1, Junction Bracket Device, has means of moving left and right on Adjustable Arm, claim 21. Said claim wherein possesses means of interconnecting, and temporarily securing adjoining devices, claim 21, and 25.

24. Claim 23, has the appearance of two short tubes positioned one on top of the other in a plus sign fashion. Each said tube possesses a Key-way for aligning and means to temporarily lock both devices, claims 21 and 25 when inserted into respective tubes of claim 23.

25. Claim 1, Adjustable Rod Device, possesses means of moving in and out of claim 24. Said device possesses same fit and functional characteristics as claim 21. Integrated at end of said device is claim 26, Attachment Bracket.

26. Claim 1, Attachment Bracket Device is integrated with claim 25 and possesses a temporary securing device and Key-Way. Key-Way provides a means to facilitate quick and easy alignment for changing of Serviceable Device, of claim 35 (a) thru (j).

27. A Universal Holding Device, Change. Said claim is a labor saving, task oriented device that is designed to interface with numerous Serviceable Devices, of claim 35, (a) thru(j). Said Claim has one basic design, three basic models/weight classes, i.e. light, medium, and heavy that can be transform into meeting needs of customers for domestic and industrial application. Said claim basic design is L-shape. Said claim is comprised of, most of the same devices of claim 1, i.e. Holding Device Body, Hinge, Ratchet-tooth with or without Quick Release Safety Knob Handle, Fixed Ann with Attachment Bracket.

28. Claim 27, Holding Device Body is same form, fit, and function as claim 2.

29. Claim 28, has several styles of Clamping Devices that are same form, fit, and function as claim 4.

30. Claim 28, Support Bracket, Removable, is same form, fit, and function as claim 5.

31. Claim 28, Hinge Devices are same design, form, fit and function as in claim 8, 11, and 17.

32. Claim 27, Ratchet-tooth Design with or without Quick Release Safety Knob Handle device is same form, fit, and function as claim 19, but maybe integrated/configured to meet customer's requirements. Some integrations/configurations may require more than one said device.

33. Claim 27, Fixed Arm is integrated with claim 32 on one side and integrated other side with Attachment Bracket Device. Said device possesses means of being replaced with different length devices.

34. Claim 34; Attachment Bracket device possesses same form, fit, and function as in claim 26.

35. Serviceable Devices all have a Quick Attachment Rod that was permanently attached for use with claims 26 and 33. Said device is a round shaft with a Key that fits Key-way in Attachment Bracket, claims 26 and 33. Serviceable Devices consist of: Baby Bottle/Sippie Cup Holder, Slug, Tray, Computer Table, Attachment Bases, Single & Multiple Hook & Eye, Mounting Bracket, Rotary Mounting Bracket, Temporary Mounting Base, and Wall Mounting Base.
(a). Baby Bottle/Sippie Cup Holder device of claim 35 has funnel shape style with small tray like extension above funnel to allow extra length of said device that doesn't fit into funnel, to lay. Said device possesses both horizontal and vertical temporary securing devices.
(b) Claim 35, Slug device is a rectangular shape, filler device with a rounded top. Said device slips over top of claim 5 and is used for attaching claim 1 to a Car Seat/Baby Carrier, that has a rounded/roll over edge.
(c). Claim 35, Tray Device possesses three shapes, i.e. rectangular, round, and square. Said claims' possess an Arm with Attachment fixture Ratchet-tooth and Quick Attachment Rod of claim 35 and Ratchet-tooth, which possesses same form, fit, and function as claim 19.
(d). Claim 35, Computer Table, Laptop/Note Book Device, is a rectangular tray like device with four sides, four L-Brackets, and two U-Brackets, each fitting into a corresponding receptacle device. Said bracket receptacles each have a temporary locking device to secure then. Said claims' Arm with Attachment fixture and Ratchet-tooth is same form, fit, and function as Claim (c).
(e). Claim 35, Attachment Bases are a family of platforms, i.e. one base with ears and metal base for attaching magnetic base devices, other bases are square, rectangular, & round, upon which a multitude of equipment can be attached. Said claims' Arm with Attachment fixture and Ratchet-tooth is same form, fit and function as Claim (c).
(f). Claim 35, Hook & Eye Devices, possesses Single Hook and Eye and Multiple Hook and Eye Devices. Said devices each possess Quick Attachment Rod of claim 35.
(g). Claim 35, Mounting Bracket holding device for claim 1 and 27. Said device possesses a temporary securing device and holes for mounting fasteners.
(h). Claim 35, Rotary Mounting Bracket is a holding device for claim 1 and 27. Said device possesses same form fit and function as Claim (g). In addition, it possesses ability to rotate 360°. After rotating to desired location said device can be secured in position with a temporary securing device.
(i) Claim 35, Temporary Mounting Base is a holding device for Claim (g) & (h). Said device possesses a clamping device for attaching said device to a secure platform. Said device possesses holes for Claims (g) & (h) to be secured.
(j) Claim 35, Wall Mounting Base is a holding device for Claim (g) & (h). Said device possesses holes for securing it to a secure vertical platform.
